(19) United States
(12) Patent Application Publication
(10) Pub. No.: US 2008/0247595 A1
(43) Pub. Date: Oct. 9, 2008

(54) Electromagnetic lever diaphragm audio transducer

(76) Inventor: Todd Henry, Dixon, IL (US)

Correspondence Address: MCANDREWS HELD & MALLOY, LTD, 500 WEST MADISON STREET, SUITE 3400, CHICAGO, IL, 60661, US

(21) Appl. No.: 12/157,011

(22) Filed: Jun. 6, 2008

Related U.S. Application Data
(63) Continuation-in-part of application No. 11/825,751, filed on Jul. 9, 2007.
Application No. 11/825,751 is a continuation-in-part of application No. 11/363,007, filed on Feb. 27, 2006.
(60) Provisional application No. 60/657,946, filed on Mar. 1, 2005.

(51) Int. Cl. H04R 1/00

(52) U.S. Cl. 381/398

(57) ABSTRACT

An electromagnetic transducer including a frame, a diaphragm disposed within the frame and coupled to the frame such that the diaphragm may rotate relative to the frame, a panel-shaped former connected to the diaphragm, a conductive coil connected to the former, and a magnetic assembly including a gap in which a magnetic field is provided. The gap is positioned to receive the conductive coil, and the conductive coil is electrically charged within the gap to move such that the diaphragm rotates about a rotational axis to generate sound waves.

### RELATED APPLICATIONS

This application is a continuation-in-part of U.S. patent application Ser. No. 11/825,751, filed Jul. 9, 2007, which is a continuation-in-part of U.S. patent application Ser. No. 11/363,007, filed Feb. 27, 2006, which claims priority to Provisional Application No. 60/657,946, filed Mar. 1, 2005, titled “Electromagnetic Lever Diaphragm Audio Transducer,” and the complete subject matter of these applications is incorporated herein by reference in their entirety.

### BACKGROUND OF THE INVENTION

The present invention relates generally to electromagnetic transducers such as those used in audio speaker systems, and more particularly to an electromagnetic audio transducer with a lever diaphragm.

An electromagnetic audio transducer is a device used to create sound in speaker systems. FIG. 1 illustrates a cross-section view of a conventional cone style electromagnetic audio transducer known as a speaker. The speaker 10 includes a round supporting frame or basket 14, a round conical diaphragm or cone 18, a conductive coil of wire known as a voice coil 22 that is wound around a former 26, and a round magnetic system 30. The magnetic system 30 includes a donut-shaped permanent magnet 38 with opposite poles positioned between top and bottom flux conducting plates 42 and 46. The speaker 10 further includes a flux conductive pole piece 50 that is either part of, or connected to, the bottom plate 46. The top plate 42 and pole piece 50 define a gap 34 therebetween. The gap 34 is a low permeability air gap in the flux path of a magnetic circuit. The pole piece 50 directs and concentrates magnetic flux 36 across the gap 34. The voice coil 22 and the former 26 are attached to the cone 18, and the cone 18 is suspended from the basket 14 by a flexible surround 51 and spider 54. The flexible surround 51 and spider 54 center the voice coil 22 in the gap 34 where the lines of magnetic flux are concentrated. The voice coil 22 is thus positioned to reciprocate specifically along an axis 40 perpendicular to the lines of magnetic flux 36 in the gap 34.

The electromagnetic audio transducer, speaker 10, is defined by the cone 18, voice coil 22, former 26, surround 51, spider 54, basket 14, and magnet system 30. An actuator comprised of a magnet system 30 and voice coil 22 define the driver of the electromagnetic audio transducer of speaker 10. In operation, the speaker 10 is mounted to an enclosure called a speaker box (not shown), and the electrically conductive voice coil 22 receives an alternating current from an audio amplifier (not shown). The electrically charged or energized voice coil 22 in turn produces a dynamic electromagnetic field that reacts with the magnetic flux 36 in the gap 34 to create a reciprocating axial driving force in the voice coil 22 such that the voice coil 22 moves up and down in the gap 34 along the axis 40 in the directions of arrows A and B. Thus, the voice coil 22, former 26, and cone 18 reciprocate as one unit relative to the speaker box displacing air to create pressure waves in air identified as sound waves.

It is common for a speaker box to have more than one speaker to form a speaker system such that the two or more speakers, each producing sound within a different range of frequencies, will be radiated away from the box completing a full range of sound in the audible sound spectrum. Most commonly, these individual speakers are known as high, mid, bass, and sub-bass. The speakers for the bass and sub-bass frequencies need to move excessively larger volumes of air to produce their low frequencies in order to maintain a sound pressure level (SPL) consistently matched with the mid and high frequency speakers.

One way to displace larger volumes of air is to increase the axial movement of the cone 18. However, the axial movement of the cone 18 is mechanically limited by the suspension system of the surround 51 and spider 54 and by the limited range of movement of the voice coil 22 within the driver. The cone 18 of the speaker 10 will move to maintain a consistent SPL with the higher frequency speakers in the speaker system up to the point where one of the mechanical limitations has been reached. However, any axial movement beyond this point will result in a decline in sound quality. The decline in sound quality is known as distortion. Distortion occurs when sound output from the speaker 10 does not identically correspond to the electrical input signal to the speaker and results in poor sound quality. Furthermore, a decline or “rolling off” of the sound pressure level occurs below this point because the cone 18 is fixed in size and cannot displace the increased volume of air required by the lower frequencies.

Another problem with conventional audio speakers is that they are not efficient. Efficiency is expressed in terms of watts and is a percentage that is derived from the ratio of electrical input power applied to the speaker to the acoustical power output transmitted from the speaker. The typical efficiencies of modern audio speakers are in the range of only a few percent. Most of the electrical output from an audio amplifier is wasted by the speaker and dissipated off in the form of heat, not sound. Thus, speaker inefficiency can be very expensive and is a significant consideration in speaker design.

The speaker 10 of FIG. 1 has an “underhung” voice coil geometry where the voice coil 22 is shorter than the depth of the gap 34. The underhung voice coil 22 is not receiving an electrical input signal and thus is illustrated at its rest position. When a positive electrical input signal is applied to a positive terminal (not shown) on the speaker 10, the voice coil 22 and cone 18 move in the direction of arrow B toward a position of “cone extension.” Conversely, when a negative electrical input signal is applied to the same terminal on the speaker 10, the voice coil 22 and the cone 18 move in the direction of arrow A toward a position of “cone retraction.” FIG. 2 illustrates the speaker 10 of FIG. 1 where the cone 18 and voice coil 22 have moved to a position of cone extension. At this position, the voice coil 22 reaches an outer edge 33 of the gap 34, which is known as the maximum linear excursion (“Xmax”) position of the voice coil 22. When the cone 18 moves in the opposite direction to the cone retraction position, the voice coil 22 reaches an inner edge of the gap 34 and is in an opposite Xmax position. The full range of motion traveled by the voice coil 22 from an extended Xmax to a retracted Xmax is known as the speakers Xmax peak-to-peak parameter. When the voice coil 22 of the speaker 10 is not energized as illustrated in FIG. 1, the suspension system (the surround 51 and spider 54) will return the coil 22 to its rest position midway between the Xmax peaks. When the voice coil 22 is energized at sufficient energy levels and particularly at low frequencies, it will reciprocate past the Xmax peak-to-peak positions, temporarily moving and operating partially out of the gap 34. The voice coil 22 is then no longer moving linearly with the electrical input signal because a portion of the voice coil 22 is not within the gap 34 and not reacting with the magnetic field and thus the output sound signal will be distorted. The efficiency of the speaker 10 will also be reduced when the voice coil 22 operates beyond its Xmax positions because the electrical input power is not producing as much force and is dissipated as heat when the voice coil 22 is outside the gap 34.

The underhung voice coil geometry of speaker 10 maintains low distortion when operated within its Xmax range. The speaker 10 is relatively efficient as long as the voice coil 22 is operated within the Xmax range and thus within the magnetic field in the gap 34. The underhung speaker 10, however, is easily driven to operate beyond the Xmax by trying to produce very low frequencies or by over-powering the voice coil 22 to produce higher sound intensity levels. Over powering will not only cause the voice coil 22 to be driven beyond its Xmax range and distort the sound, it will also cause the voice coil 22 of the speaker 10 to quickly reach its thermal limit and overheat. Thus, the underhung voice coil geometry of speaker 10 in FIG. 1 is not able to produce undistorted high sound intensity levels at a lower frequency range and is better suited for higher efficiencies and lower distortion at the upper ranges of its bass frequencies.

The underhung voice coil geometry of speaker 10 of FIG. 1 can be modified to produce higher sound intensity levels at lower frequencies by using a larger top plate 42 and a correspondingly taller pole piece 50 to define a deeper gap 34 in which the voice coil 22 may travel further before reaching Xmax peak-to-peak. However, this “highly underhung” voice coil geometry can be less efficient than a standard underhung arrangement because the flux 36 (FIG. 1) in the gap 34 will not be as strongly concentrated due to the increase in surface area of the top plate 42.

FIG. 3 illustrates another conventional speaker 10a designed to overcome some of the drawbacks of the underhung speaker 10 (FIG. 1). The speaker 10a has an “overhung” voice coil geometry that extends out beyond the gap 34a from both ends when the voice coil 22a is at rest. The top plate 42a, and thus the gap 34a, is thin like that found in the underhung speaker 10 of FIG. 1 so that the flux 36a density is highly concentrated. As with the speaker 10 of FIG. 1, the speaker 10a moves in the direction of arrow B to cone extension or in the direction of arrow A to cone retraction depending on the polarity of the electrical input signal.

FIG. 4 illustrates the speaker 10a of FIG. 3 where the cone 18a has moved to the cone extension position and the voice coil 22a has moved to an Xmax in the direction of arrow B from the rest position. At this Xmax position, an inner edge of the voice coil 22a reaches an inner edge of the gap 34a. When the cone 18a moves in the opposite direction to the cone retraction position, the voice coil 22a moves in the direction of arrow A to an Xmax position past the rest position to where an outer edge of the voice coil 22a reaches an outer edge of the gap 34a. The voice coil 22a can move further along the axis 40a than can the underhung voice coil 22 in speaker 10 of FIG. 1 and thus produce a higher SPL at lower frequencies before distortion occurs. The larger voice coil 22a can also handle larger amounts of power. However, the voice coil 22a can be less efficient because a portion of the voice coil 22a is always operating outside of the gap 34a and thus wasting power. Furthermore, the larger size and mass of the voice coil 22a increases the opposing inertial forces acting on it such that the cone 18a cannot move as efficiently or fast to produce the higher frequencies as it could with the smaller voice coil 22 of the underhung speaker 10 (FIG. 1). Thus, a reduction in the efficiency in the upper range of bass frequencies may occur.

Conventional cone style speakers have another drawback when multiple speakers, each producing a different range of frequencies, are combined together within a single controlled space, such as a horn, to create a full range speaker system. Examples of such speaker systems are disclosed in U.S. Pat. Nos. 5,526,456 and 6,411,718. Because of the irregular shape of their conical diaphragms (the speaker cone), the low and mid frequency transducers in this type of speaker system positioned in the walls of the horn disrupt the paths of the higher frequencies produced by the high frequency transducers near the apex of the horn. In order to prevent the conical diaphragms from disrupting the paths of the higher frequencies, special adapters and apertures are added to the horn to maintain the continuity of the horn wall. Also, the round periphery of a conical diaphragm does not maximize use of the available horn wall area upon which it is mounted and thus wastes useful horn wall space.

Therefore, a need exists for a transducer for use in an audio speaker system that is capable of producing high sound intensity levels while maintaining high electrical efficiencies and low distortion and that may be combined with other audio transducers in a speaker system such that it can provide continuity in the wall of a horn and a low disruptive path for the sound waves emitted by the other audio transducers within the speaker system.

### BRIEF SUMMARY OF THE INVENTION

Certain embodiments of the present invention include a transducer. The transducer includes a frame and a panel disposed within the frame and coupled to the frame such that the panel may rotate relative to the frame about a rotational axis. The transducer includes an actuator positioned to engage the panel such that the panel rotates about the rotational axis to displace air.

Certain embodiments of the present invention include an electromagnetic transducer having a frame and a panel disposed within the frame and coupled to the frame such that the panel may rotate relative to the frame about a rotational axis at the coupling between the panel and the frame. The transducer includes a conductive coil coupled to the panel and a magnetic structure coupled to the frame. The magnetic structure includes a gap in which a magnetic field is provided, and the gap is positioned to receive the conductive coil. The conductive coil is electrically charged within the gap to move such that the panel rotates about the rotational axis to displace air.

Certain embodiments of the present invention include a speaker system. The speaker system includes an enclosure, a frame mounted to the enclosure, and a panel disposed within the frame and coupled to the frame such that the panel may rotate relative to the frame about a rotational axis at the coupling between the panel and the frame. The panel has an inner side facing toward the enclosure and an outer side facing out from the enclosure. The speaker system includes a conductive coil coupled to the panel and a magnetic structure connected to the frame. The magnetic structure includes a gap in which a magnetic field is provided. The gap is positioned to receive the conductive coil. The conductive coil is electrically charged within the gap to move such that the panel rotates about the rotational axis and the inner face displaces air within the enclosure and the outer face displaces air outside of the enclosure such that sound waves are formed.

Certain embodiments of the present invention include a speaker system. The speaker system includes a horn having walls defining a flared section from a throat to a mouth and at least one electromagnetic audio transducer disposed along one of the walls of the horn. The at least one electromagnetic audio transducer includes a frame, a trapezoidal-shaped panel disposed within the frame and having an inner face and an outer face, a conductive coil coupled to the inner face, and a magnetic structure connected to the frame. The conductive coil is electrically charged relative to the magnetic structure such that the trapezoidal-shaped panel moves relative to the frame to produce sound waves within the horn.

Certain embodiments of the present invention include a speaker. The speaker includes a baffle and a panel disposed within the baffle and coupled to the baffle such that the panel may rotate relative to the baffle about a rotational axis. The speaker includes an actuator positioned to engage the panel such that the panel rotates about the rotational axis to displace air.

Certain embodiments of the present invention include a speaker system. The speaker system includes a horn having walls extending from a throat of the horn to a mouth of the horn and defining a cavity within the horn. At least one of the walls includes a panel that is contoured to the shape of the wall and that is configured to move with respect to the wall. A driver is disposed proximate the at least one wall and configured to cause the panel to vibrate and emit sound waves into the cavity of the horn.

Certain embodiments of the present invention include a speaker system. The speaker system including a horn having walls extending from a throat of the horn to a mouth of the horn and defining a cavity within the horn. The speaker also includes a high frequency driver positioned in the throat of the horn and configured to emit first sound waves into the cavity wherein the walls guide the path of the first sound waves. A panel is disposed within at least one of the walls. The panel is contoured to the shape of the wall and configured to guide the path of the first sound waves as part of the wall. The panel is configured to move with respect to the wall. The speaker system also includes a second driver disposed along the at least one wall and configured to cause the panel to vibrate and emit second sound waves into the cavity of the horn.

Certain embodiments of the present invention include a speaker system. The speaker system includes a horn having walls defining a flared cavity section from a throat to a mouth. The speaker system also includes a first electromagnetic audio transducer disposed within one of the walls of the horn. The first electromagnetic audio transducer includes a panel having a smooth surface exposed to the cavity section and being contoured to the shape of the wall and a driver connected to the panel and configured to vibrate the panel relative to the wall such that the panel emits first sound waves within the cavity section. The speaker system includes a second electromagnetic audio transducer disposed within the horn and configured to emit second sound waves within the cavity section. The wall and the panel define a pathway for the second sound waves. The first and second sound waves combine within the cavity section and are emitted from the horn.

Certain embodiments of the present invention include an electromagnetic transducer. The transducer includes a frame, a diaphragm disposed within the frame and coupled to the frame such that the diaphragm may rotate relative to the frame, a panel-shaped former connected to the diaphragm, a conductive coil connected to the former, and a magnetic assembly including a gap in which a magnetic field is provided. The gap is positioned to receive the conductive coil, and the conductive coil is electrically charged within the gap to move such that the diaphragm rotates about a rotational axis to generate sound waves.

Certain embodiments of the present invention include an electromagnetic transducer for use in a speaker. The transducer includes a frame, a diaphragm disposed within the frame and coupled to the frame such that the diaphragm may rotate relative to the frame, a former connected to the diaphragm, wherein the former is a curved panel, a conductive coil connected to the former and configured to curve along the former, and a magnetic assembly including a gap in which a magnetic field is provided. The gap is positioned to receive the conductive coil, and the conductive coil is electrically charged within the gap to move such that the diaphragm rotates relative to the frame to generate sound waves.

Certain embodiments of the present invention include an electromagnetic transducer for use in a speaker. The transducer includes a frame, a diaphragm disposed within the frame and coupled to the frame such that the diaphragm may rotate relative to the frame. The diaphragm has top and bottom sides and includes a curved surface on at least one of the top and bottom sides and includes at least one groove along the surface of at least one of the top and bottom sides. The transducer also includes a conductive coil connected to the diaphragm, and a magnetic structure connected to the frame. The magnetic structure includes a gap in which a magnetic field is provided, and the gap is positioned to receive the conductive coil. The conductive coil is electrically charged within the gap to move such that the diaphragm rotates about the rotational axis to displace air and generate sound waves.

### BRIEF DESCRIPTION OF SEVERAL VIEWS OF THE DRAWINGS

FIG. 1 illustrates a cross-sectional view of a prior art speaker.

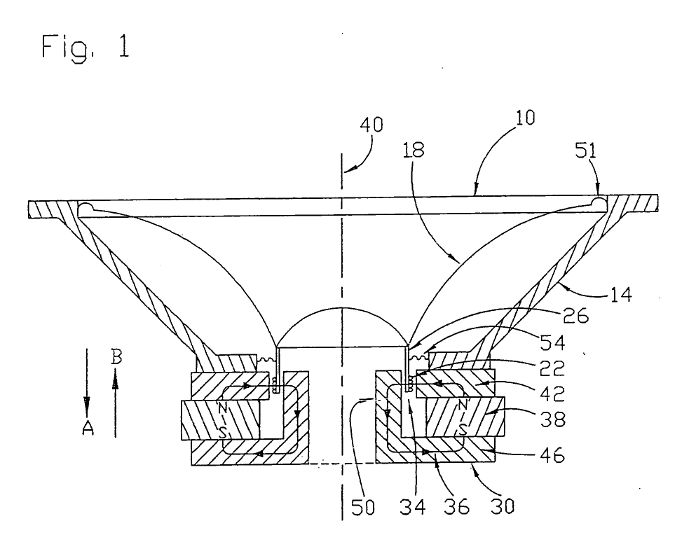

FIG. 2 illustrates the speaker of FIG. 1 in a cone extension position.

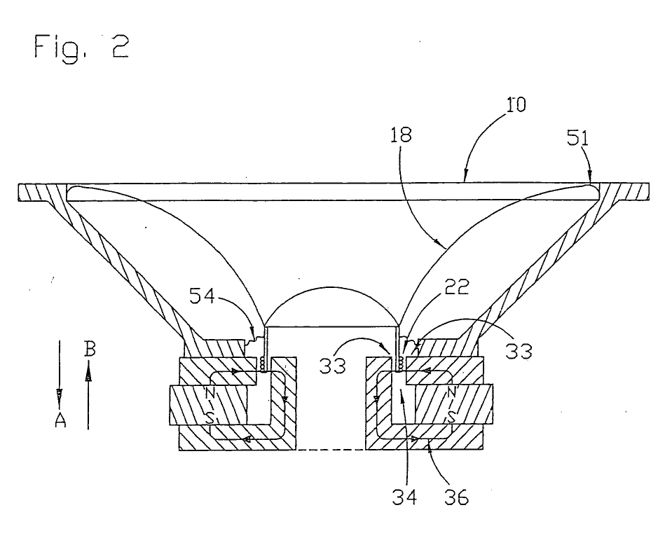

FIG. 3 illustrates a cross-sectional view of a prior art speaker.

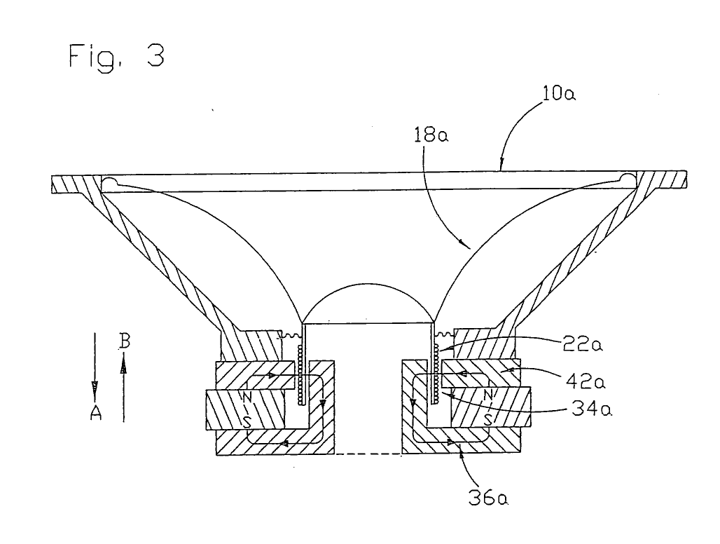

FIG. 4 illustrates the speaker of FIG. 3 in a cone extension position.

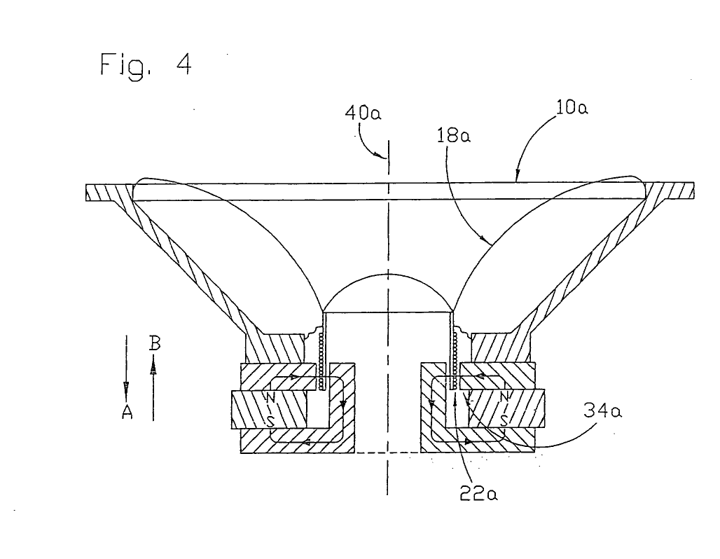

FIG. 5 illustrates a front isometric view of an electromagnetic audio transducer formed according to an embodiment of the present invention.

FIG. 6 illustrates a bottom isometric view of the electromagnetic audio transducer of FIG. 5.

FIG. 7 illustrates a front isometric view of a speaker system formed according to an embodiment of the present invention.

FIG. 8 illustrates an exploded isometric view of the electromagnetic audio transducer of FIG. 6.

FIG. 9 illustrates a bottom view of the magnet box of FIG. 6.

FIG. 10 illustrates a bottom view of a magnet box receiving a voice coil formed according to an embodiment of the invention.

FIG. 11 illustrates a cross-sectional side view of the electromagnetic audio transducer of FIG. 6 taken along line 11-11.

FIG. 12 illustrates a partial side view of the electromagnetic audio transducer of FIG. 11.

FIG. 13 illustrates a partial side view of the electromagnetic audio transducer of FIG. 11.

FIG. 14 illustrates an isometric view of a lever system representing the operation of the lever diaphragm in the electromagnetic audio transducer formed according to an embodiment of the present invention.

FIG. 15 illustrates a partial cross-sectional side view of an electromagnetic audio transducer formed according to an embodiment of the present invention.

FIG. 16 illustrates a partial cross-sectional side view of an electromagnetic audio transducer formed according to an embodiment of the present invention.

FIG. 17 illustrates a partial cross-sectional side view of an electromagnetic audio transducer formed according to an embodiment of the present invention.

FIG. 18 illustrates a cross-sectional side view of an electromagnetic audio transducer formed according to an embodiment of the present invention.

FIG. 19 illustrates a cross-sectional side view of an electromagnetic audio transducer formed according to an embodiment of the present invention.

FIG. 20 illustrates a cross-sectional top view of a speaker system formed according to an embodiment of the present invention.

FIG. 21 illustrates a cross-sectional top view of a speaker system formed according to an embodiment of the present invention.

FIG. 22 illustrates a side view of a speaker horn formed according to an embodiment of the present invention.

FIG. 23 illustrates a top cross-sectional view of the speaker horn of FIG. 22 taken along lines 23-23.

FIG. 24 illustrates a side view of a speaker horn formed according to an embodiment of the present invention.

FIG. 25 illustrates a top cross-sectional view of the speaker horn of FIG. 24 taken along lines 25-25.

FIG. 26 illustrates a cross sectional side view of a panel mounted within a baffle formed according to an embodiment of the present invention.

FIG. 27 illustrates an isometric front view of the panel and baffle of FIG. 26.

FIG. 28 illustrates an isometric front view of a panel mounted within a baffle of a speaker box formed according to an embodiment of the present invention.

FIG. 29 illustrates a cross-sectional top view of a speaker system according to an embodiment of the present invention.

FIG. 30 illustrates a cross-sectional top view of a speaker system according to an embodiment of the present invention.

FIG. 31 illustrates the speaker system of FIG. 31 with a high frequency driver emitting sound waves.

FIG. 32 illustrates a cross-sectional top view of a speaker system according to an embodiment of the present invention.

FIG. 33 illustrates a cutaway side view of a speaker according to an embodiment of the present invention.

FIG. 34 illustrates a cross-sectional top view of a speaker system according to an embodiment of the present invention.

FIG. 35 illustrates a cross-sectional top view of a speaker system according to an embodiment of the present invention.

FIG. 36 illustrates a cross-sectional top view of a speaker system according to an embodiment of the present invention.

FIG. 37 illustrates a cutaway view of the speaker system of FIG. 36 taken along section lines 37-37.

FIG. 38 illustrates a cross-sectional top view of a speaker system according to an embodiment of the present invention.

FIG. 39 illustrates a cross-sectional top view of a speaker system according to an embodiment of the present invention.

FIG. 40 illustrates a front view of an active speaker wall panel according to an embodiment of the present invention.

FIG. 41 illustrates a front view of a speaker system according to an embodiment of the present invention.

FIG. 42 illustrates a front view of a speaker system according to an embodiment of the present invention.

FIG. 43 illustrates a partial cross-sectional side view of an electromagnetic audio transducer formed according to an embodiment of the present invention.

FIG. 44 illustrates a front view of a voice coil and former formed according to an embodiment of the present invention.

FIG. 45 illustrates a front view of a voice coil and former formed according to an embodiment of the present invention.

FIG. 46 illustrates a side view of the voice coil and former of FIG. 44.

FIG. 47 illustrates a side cross-sectional view of an electromagnetic audio transducer formed according to an embodiment of the present invention.

FIG. 48 illustrates a side cross-sectional view of an electromagnetic audio transducer formed according to an embodiment of the present invention.

FIG. 49 illustrates a bottom view of a panel formed according to an embodiment of the present invention.

FIG. 50 illustrates a cross-sectional side view of the panel of FIG. 49 taken along line 50-50.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentality shown in the attached drawings.

### DETAILED DESCRIPTION OF THE INVENTION

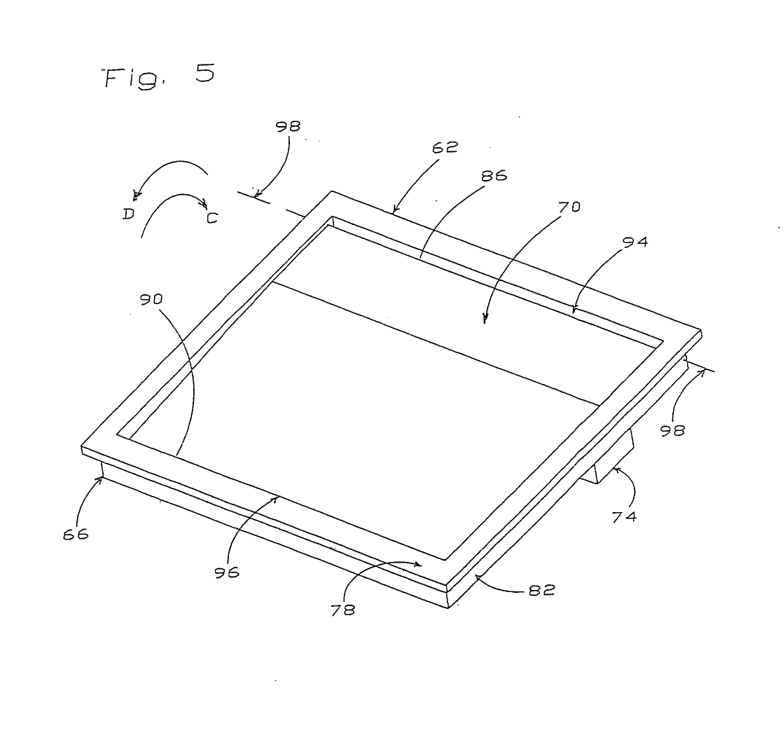

FIG. 5 illustrates a front isometric view of an electromagnetic audio transducer 62. The transducer 62 includes a frame 66, a panel or diaphragm 70, and a magnet box 74. The frame 66 is an enclosed, generally square shape with a face 78 formed integrally with a side wall 82. The frame 66 may be made of any number of rigid materials and, by way of example only, is made of metal and specifically aluminum. The panel 70 is generally planar and may be made of any number of rigid, lightweight materials. By way of example only the panel 70 may be made of a rigid foam. The panel 70 has a pivot end 86 and a tip end 90. The panel 70 may have grooves or a honeycombed structure or any other means to reduce mass and maintain its rigidity. The pivot end 86 of the panel 70 is connected to a first side 94 of the frame 66 such that the panel 70 can pivot about a rotational axis 98 in the directions of either arrows C or D. The tip end 90 of the panel 70 is free to move proximate a second side 96 of the frame 66. The pivot end 86 may be connected to the first side 94 of the frame 66 by any number of methods that allow the pivoting motion.

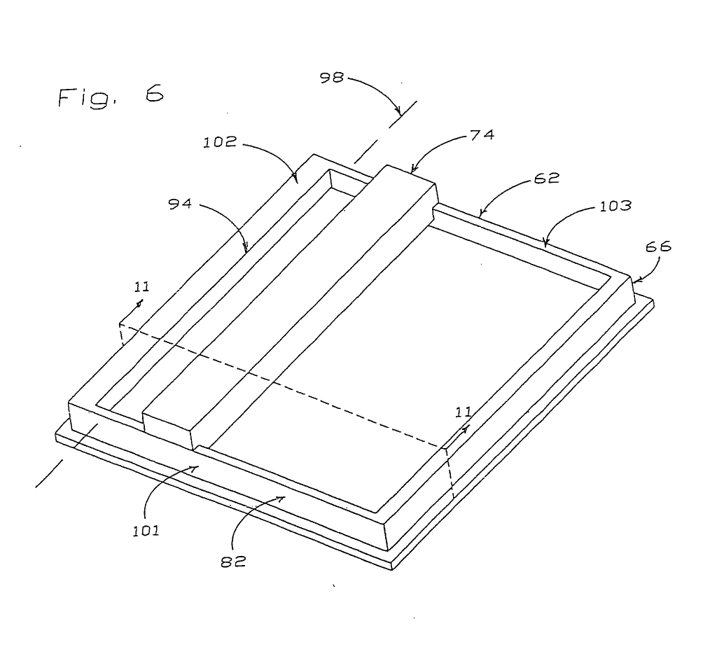

FIG. 6 illustrates a bottom isometric view of the electromagnetic audio transducer 62 of FIG. 5. The magnet box 74 is a hollowed block shaped member that contains an array of magnets and that is mounted on a back side 102 of the frame 66 to opposite first and second members 101 and 103 of the side wall 82. The magnet box 74 may be detachably mounted on the back side 102 of the frame 66 along the side wall 82 at any number of distances from the first side 94 of the frame 66 generally parallel to the rotational axis 98.

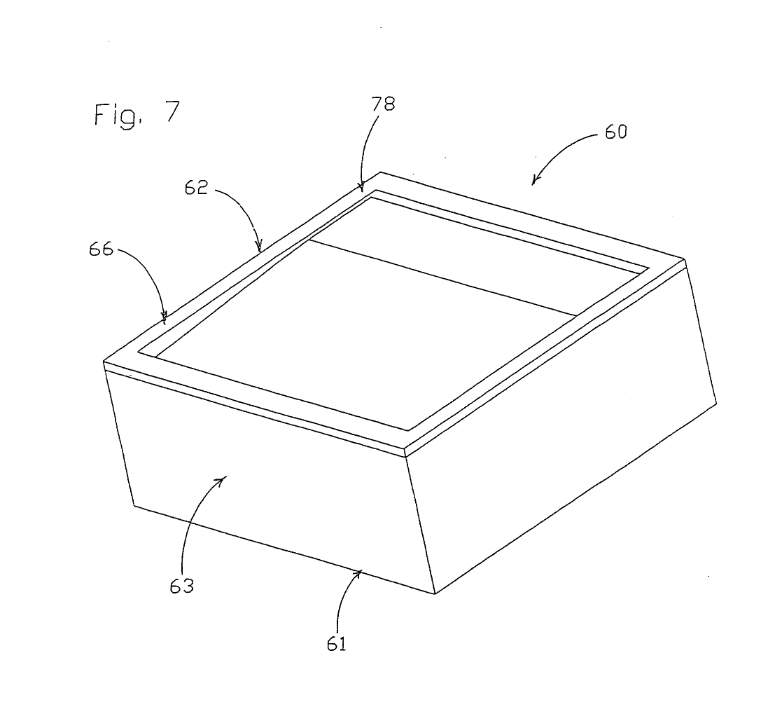

FIG. 7 illustrates a front isometric view of a speaker system 60. The speaker system 60 includes the electromagnetic audio transducer 62 mounted to a speaker box 61 such that the speaker box 61 encloses one side of the transducer 62. The speaker box 61 may also be referred to as an enclosure. The side wall 82 (FIG. 5) of the frame 66 is received within an aperture of the speaker box 61 and the face 78 fits on an exterior wall 63 of, and faces out from, the speaker box 61. It will be understood that the electromagnetic audio transducer 62 and its components and the speaker box 61 may take on any number of different sizes, shapes, or configurations according to the intended use and design of the speaker system.

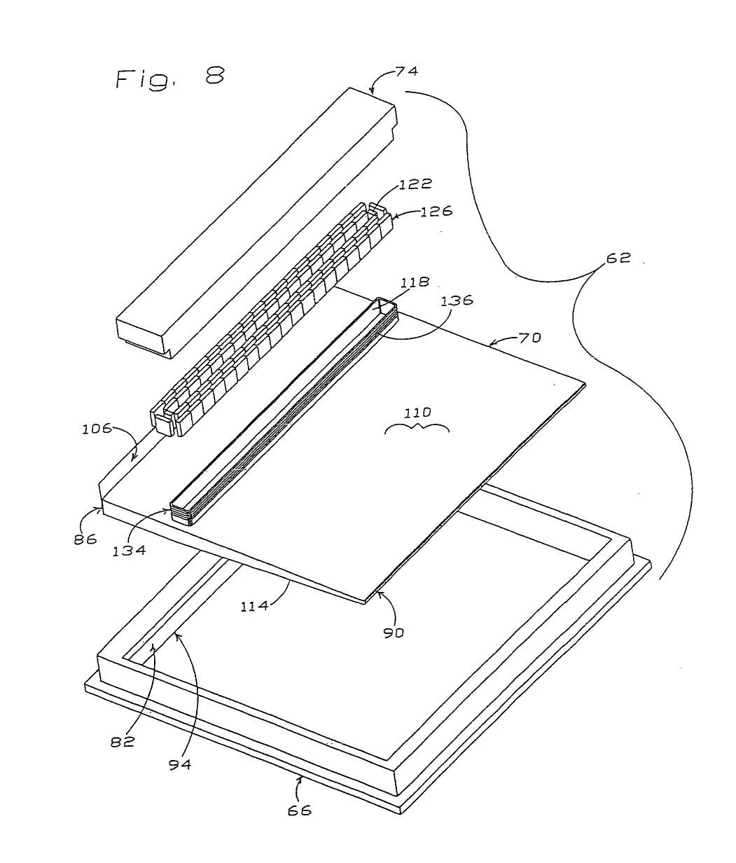

FIG. 8 illustrates an exploded isometric view of the electromagnetic audio transducer 62 of FIG. 6. The panel 70 has an inner side 110 and an outer side 114. The outer side 114 gradually angles toward the inner side 110 such that the panel tapers down in thickness from the pivot end 86 to the tip end 90. Alternatively, the panel 70 may have any number of other shapes besides the tapered one shown. By way of example only, the panel 70 may be completely flat with a constant thickness, or may be wedge-shaped, or may have a curved and/or tapering inner or outer side 110 or 114 with a straight opposite side, or may be angled on one of, or both, the inner and outer sides 110 and 114, or may be curved on both the inner and outer sides 110 and 114, or may have any combination of shapes, angles, tapers, or curves. The panel 70 is connected to a thin sheet 106 of metal such as spring steel. Alternatively, the sheet 106 may be made of any number of flexible materials. The panel 70 may be connected to the sheet 106 by glue, epoxy, or any number of other methods.

When the panel 70 is assembled to the frame 66, the thin sheet 106 is connected to the side wall 82 at the first side 94 of the frame 66 by bolting, clamping, pinning, or any number of other methods of fastening such that the panel 70 is able to pivot proximate the first side 94. Alternatively, the panel 70 may be coupled to the frame 66 at the first side 94 or at the side members 101 and 103 (FIG. 6) or in any combination thereof by an axle, or hinge, or bushing, or bearing, or any other means such that the panel 70 is able to rotate about an axis relative to the frame 66. The transducer 62 may include a spring, elastic material, or magnetic system, or any other means to maintain the panel 70 in a centered position within the frame 66. The panel 70 includes a long rectangular-shaped former 118 attached to the inner side 110. The former 118 may be made of any number of rigid, light-weight, and heat resistant materials. A series of electrically conductive turns of wire 136 are wrapped around the former 118 to form a conductive voice coil 134 that is coupled to the panel 70 by way of the former 118. The magnet box 74 receives therein a magnetic structure including a magnet providing a magnetic field. For example, the magnetic structure includes an inner magnet group 122 and an outer magnet group 126.

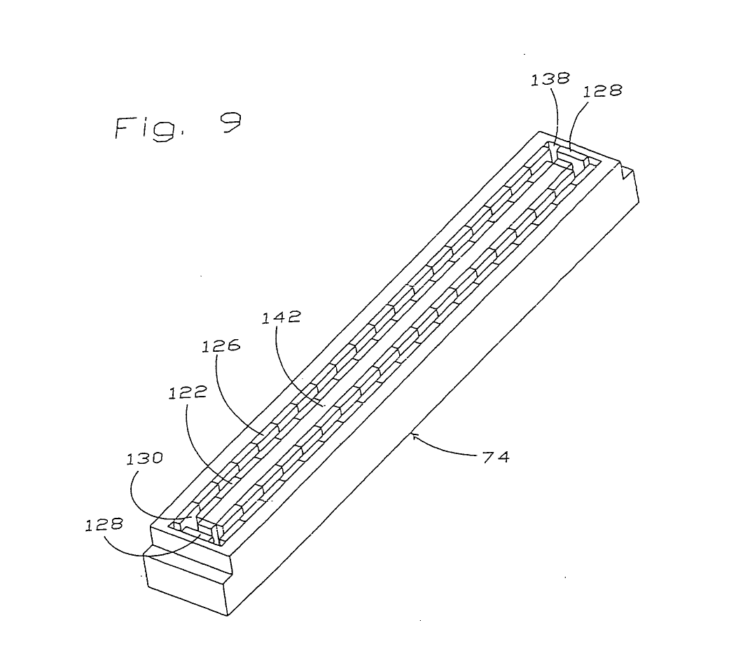

FIG. 9 illustrates a bottom view of the magnet box 74 containing the inner and outer magnet groups 122 and 126. The outer magnet group 126 is positioned along an inner wall 138 of the magnet box 74 and the inner magnet group 122 is positioned along a center wall 142 of the magnet box 74. The inner and outer magnet groups 122 and 126 may be connected to the inner wall 138 and center wall 142, respectively, by any number of methods, for example, by glue or epoxy. The inner and outer magnet groups 122 and 126 define a gap 130 therebetween. A magnetic field is provided within the gap 130 by the magnetic structure through the opposing-polarity inner and outer magnet groups 122 and 126, which are also positioned along short sides 128 of the magnet box 74.

Returning to FIG. 6, when the electromagnetic audio transducer 62 is assembled, the magnet box 74 contains the inner and outer magnet groups 122 and 126 (FIG. 9) and is mounted on the frame 66 to receive the former 118 (FIG. 8) and the voice coil 134 (FIG. 8) within the gap 130 (FIG. 9) between the inner and outer magnet groups 122 and 126. The magnet box 74 and the voice coil 134 define the driver or actuator of the transducer 62. Not shown in FIG. 6 are the electric terminal connectors with wire leads providing continuity between the terminal connectors and the voice coil. These connectors are used to provide a point of electrical input to the voice coil from an amplifier, which is also not shown. It will be understood that the connectors and amplifier can be adapted for use in the embodiments herein.

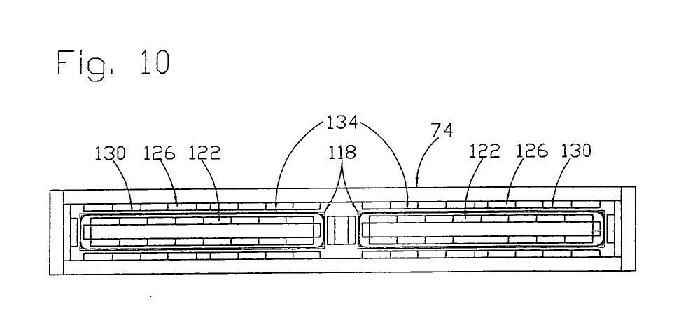

Alternatively, the magnet box 74 and inner and outer magnet groups 122 and 126 may have different shapes to define a differently shaped gap 130 that corresponds to a differently shaped voice coil 134. For example, referring to FIG. 10, the single long rectangular former 118 and voice coil 134 of FIG. 8 may be divided into a plurality of shorter formers 118 and voice coils 134 that are received within a correspondingly arranged magnet box 74 with the inner and outer magnet groups 122 and 126 arranged to define gaps 130 to receive the voice coils 134. Alternatively, the formers 118 and voice coils 134 may have different shapes, such as square, cylindrical, or even a flat over-under vertically wound and positioned voice coil that may be received in correspondingly shaped magnet boxes 74 and gaps 130.

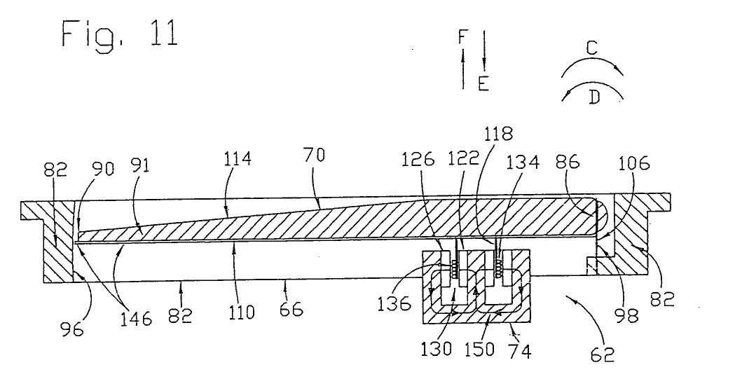

FIG. 11 illustrates a cross-sectional side view of the electromagnetic audio transducer 62 of FIG. 6 taken along line 11-11. The second side 96 of the side walls 82 of the frame 66 is curved to accommodate the radial movement of the tip end 90 of the panel 70 and to maintain a generally constant distance between the tip end 90 and the second side 96 of the frame 66. The tip end 90 and its two adjacent side ends 91 of the panel 70 include a seal 146 on the inner side 110 that extends toward the side walls 82 but does not engage the side walls 82. The seal 146 is a low friction, light-weight, and flexible material that aids in sealing the inner side 110 of the panel 70 from the outer side 114 without engaging the side walls 82 of frame 66 to create friction. If the seal does contact the side wall 82, the low frictional seal material allows the panel to slide along the walls 82 with little resistance. Alternatively, the seal 146 may be located on the outer side 114 of the panel 70 or on both the inner and outer sides 110 and 114 of the panel 70. When the panel 70 is in the rest position as shown, the wire turns 136 of the voice coil 134 are positioned within the gap 130 of the magnet box 74.

In operation, the electromagnetic audio transducer 62 of FIG. 11 is positioned in the speaker box 61 (FIG. 7) such that the speaker box 61 pneumatically isolates the inner side 110 of the panel 70 from the outer side 114 of panel 70. The voice coil 134 is connected to an audio amplifier (not shown) that provides an alternating current electrical input signal to the voice coil 134 such that the voice coil 134 creates an alternating electromagnetic field. The alternating electromagnetic field reacts with a magnetic flux 150 provided in the gap 130 by the inner and outer magnet groups 122 and 126 such that the voice coil 134 moves within the gap 130 generally in the directions of arrows E and F. The movement of the voice coil 134 in the directions of arrows E and F in turn applies reciprocating torque forces to the panel 70 through the former 118 such that the panel 70 rotates at the pivot end 86 about the rotational axis 98 along the sheet 106 in the directions of arrows D and C, respectively. The tip end 90 of panel 70 thereby moves in a radial path about the rotational axis and within the confines of the frame 66. The conductive voice coil moves in a radial path about the rotational axis within the gap 130 of the magnet box 74. As the panel 70 moves within the frame 66 and the speaker box 61 (FIG. 7), the panel 70 creates pressure waves in the air. As the inner side 110 of the panel 70 produces a positive pressure wave, the outer side 114 of the panel 70 produces a negative pressure wave. Because the air pressure produced by the inner side 110 of the panel 70 is received in the speaker box 61, the air pressure waves produced by the outer side 114 of the panel 70 are emitted into the surrounding air outside of the speaker box 61. The displacement of air at a frequency corresponding to the input electrical signal from the audio amplifier creates sound waves.

Additionally, the transducer 62 is not limited to use with a driver or actuator that includes the magnet box 74 and voice coil 134 to move the panel 70. Rather, the panel 70 can be moved to rotate relative to the frame 66 by any machine, or driver, that transmits motion or power to the panel 70. Alternatively, the thin flexible strip 106 in FIG. 11 (shown positioned and attached perpendicular to panel to 70 and parallel to side wall 82) may be rotated 90 degrees and attached parallel to the panel 70 on the inner side 110 or the outer side 114 and perpendicularly attached to the side wall 82.

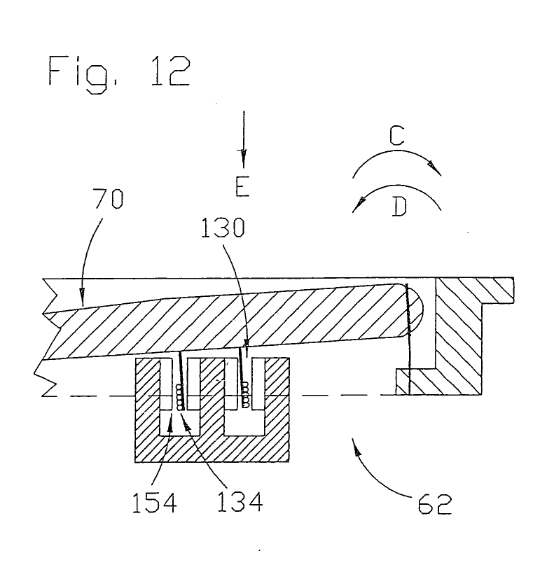

FIG. 12 illustrates a partial cross-sectional side view of the electromagnetic audio transducer 62 of FIG. 11. An electrical input signal drives the voice coil 134 in the direction of arrow E to a peak position at an outer edge 154 of the gap 130 but still within the gap 130. The voice coil 134 is in a first Xmax position. As the voice coil 134 moves in the direction of arrow E to its Xmax position, the panel 70 rotates in the direction of arrow D from the rest position of FIG. 11 to a diaphragm retraction position. Also, the tip end 90 (FIG. 11) of the panel 70 similarly moves to a maximum retracted position that is still within the confines of the frame 66 (FIG. 11). When the electrical signal changes direction, the voice coil 134 and the panel 70 then rotate in the direction of arrow C.

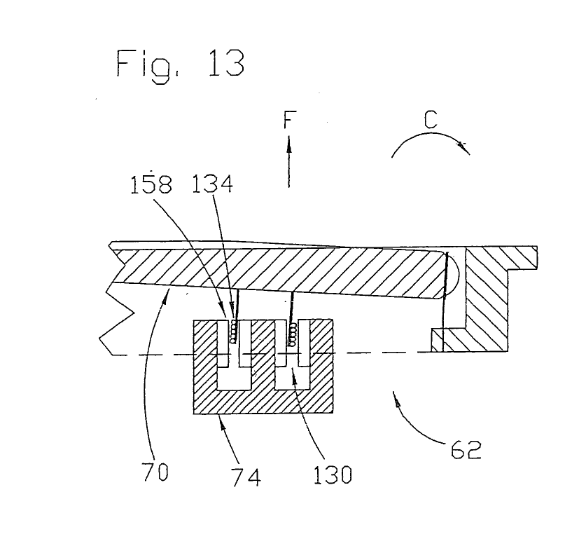

FIG. 13 illustrates a partial cross-sectional side view of the electromagnetic audio transducer 62 of FIG. 11. An electrical input signal drives the voice coil 134 in the direction of arrow F to a peak position at an inner edge 158 of the gap 130 but still within the gap 130. The voice coil 134 is in a second Xmax position. As the voice coil 134 moves in the direction of arrow F to its Xmax position, the panel 70 rotates in the direction of arrow C to a diaphragm extension position. Also, the tip end 90 (FIG. 11) of the panel 70 similarly moves to a maximum extension position that is within the confines of the frame 66 (FIG. 11). The magnet box 74 is positioned in relation to the panel 70 such that the voice coil 134 stays positioned within the gap 130 as the panel 70 moves across its full range of motion between the diaphragm retraction position and the diaphragm extension position. Because the voice coil 134 remains in the gap 130, the transducer 62 maintains a higher speaker efficiency and lower distortion while being able to produce greater air displacements resulting in higher sound pressure levels, especially at lower frequency ranges.

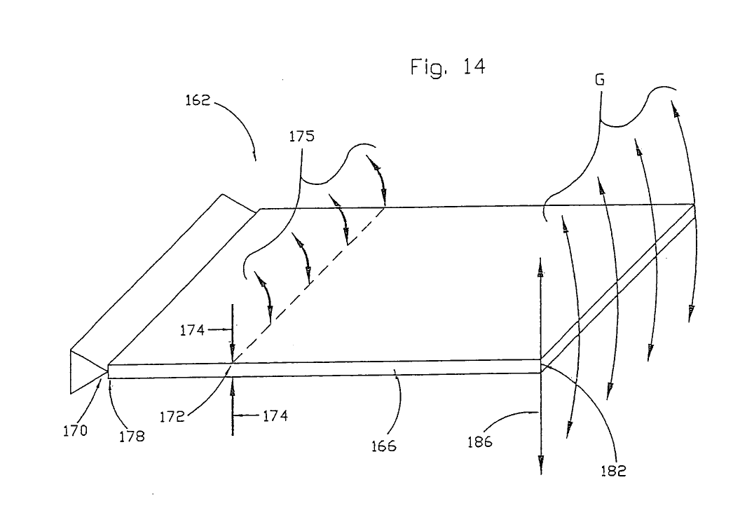

The radial movement and the mechanical method for creating the radial movement of the “lever diaphragm” of the electromagnetic audio transducer 62 (FIG. 11) enables this transducer to overcome many of the problems associated with conventional electromagnetic transducers that operate in a linear-axial motion. The mechanics and advantages of this electromagnetic lever diaphragm audio transducer 62 (FIG. 11) can best be understood by a cursory review of the mechanics of levers. FIG. 14 illustrates an isometric view of a lever system 162 representing the operation of the “lever diaphragm” of the electromagnetic audio transducer 62 (FIG. 11). The lever system 162 includes an arm or panel 166, a fulcrum 170, and an input force 174 representing the force created when the voice coil 134 (FIG. 11) is energized in the gap 130 (FIG. 11). The input force 174 is a reciprocating force that can be applied on both sides of the panel 166 and that can be applied across the entire width of the panel 166 and creates a reciprocating output force 186 at an end 182 of the panel 166. The input force 174 applied across the width of the panel 166 causes the panel 166 to rotate as shown by arrows G. A torque or moment 175 is a product of the input force 174 applied to a point 172, which extends along the width of the panel 166, and the distance between the point 172 and the moment center or fulcrum 170. Far end 182 moves the greatest distance of any point on the panel 166 while near end 178 moves the shortest distance of any point on the panel 166. The force applied by, and distance traveled by, any point on the panel 166 is a function of the mechanical advantage ratio of the distance of the input force 174 from the fulcrum 170 to the entire length of the panel 166. For example, the input force 174 is being applied away from the fulcrum 170 at the point 172 which is about ¼ the length of the panel 166. Based on this ratio of mechanical advantage, the input force 174 is four times the output force 186 realized at the end 182 of the panel 166, but the end 182 of the panel 166 travels 4 times the distance that the point 172 travels. Thus, this lever system 162 is a motion-amplifying lever beyond point 172 toward end 182.

Returning to FIG. 11, the lever action of the diaphragm in the electromagnetic audio transducer 62 enables it to maximize the movement of the panel 70, and thus the displacement of air to make sound, while minimizing the movement of the voice coil 134. For example, the magnet box 74 and voice coil 134 are positioned to operate and apply torque forces on the panel 70 at an area along the panel 70 approximately ¼ the length of the panel 70 from the pivot end 86 (the approximate point of the fulcrum). Based on the mechanical advantage ratio, the tip end 90 of the panel 70 moves four times the distance than does the area on the panel 70 where the torque forces are applied by the voice coil 134 and former 118. Therefore, unlike the axially-moving diaphragm of a conventional transducer where the voice coil must travel the same linear distance as the cone, and thus the movement of the entire cone is limited to maintain the voice coil in the gap, a large portion of the panel 70 can be moved a far greater distance than the voice coil 134 while the voice coil 134 can remain in the gap 130. In other words, the movement of the panel 70 is not limited by a 1:1 ratio to the movement of the voice coil 134 as in conventional axially-moving cone type audio transducers. Rather, the area close to the tip end 90 of the panel 70 moves a greater distance than the voice coil 134 moves by a ratio of greater than 1:1 as a function of where on the panel 70 the voice coil 134 is located. The closer the voice coil 134 and magnet box 74 are positioned to the pivot end 86 of audio transducer 62, the greater the proportion the distance the tip end 90 travels relative to the distance the voice coil 134 travels. Thus, the “lever diaphragm” of the electromagnetic audio transducer 62 can displace more air than conventional axially-moving cone type speakers while limiting the movement of the voice coil 134 to within the gap 130. Because the voice coil 134 does not have to leave the gap 130 for excessive diaphragm-air displacements, it can take on additional electrical input power and convert it to force, not just heat. In this way, the electromagnetic lever diaphragm audio transducer 62 is able to receive more electrical input power to generate higher intensity sound levels without increasing distortion or sacrificing efficiency.

The mechanical advantage ratio of the electromagnetic lever diaphragm audio transducer 62 may easily be altered to accommodate different speaker requirements. For example, because the force applied to the panel 70 from the driver is a torque and is easily changed by the positioning of the driver on the frame 66 relative to the rotational axis 98, a speaker utilizing this lever diaphragm arrangement can be easily “tuned” for a specific use. Such uses may include horn loading, sealed box direct radiator, bass-reflex, and wave-guide horns applications. Another advantage related to the positioning of the driver relative to the rotational axis 98 of the panel is the capability of altering the amount of air the panel 70 can displace. By moving the driver closer to the rotational axis 98, the tip end 90 (FIG. 11) of the panel 70 moves a greater distance relative to the distance the voice coil 134 travels in the gap 130, and thus displaces more air. Due to their structure and operation, conventional axial-reciprocating audio transducers can not easily be modified to alter the amount of force applied to the diaphragm or the distance the diaphragm travels to displace air.

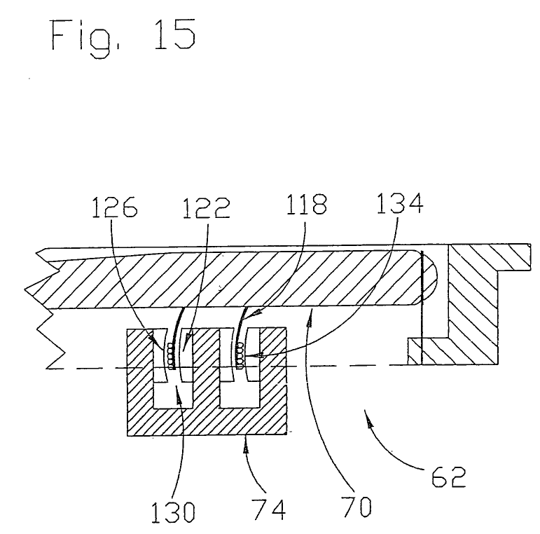

Alternatively, as shown in FIG. 15, the structure of the voice coil 134 and the magnet box 74 may be altered to increase the efficiency of the electromagnetic audio transducer 62. The former 118 and voice coil 134 are curved and the inner magnet group 122 and the outer magnet group 126 are likewise curved to create a curved gap 130 to receive the curved voice coil 134. The curvature of the voice coil 134 and the gap 130 accommodates the radial movement of the panel 70 such the voice coil 134 is always situated generally at the same distance from both the inner and outer magnet groups 122 and 126 as the voice coil 134 moves along a radial path within the gap 130. Because the voice coil 134 does not move any closer to, or further from, either the inner or outer magnet groups 122 or 126 during movement, the gap 130 can be narrower than if the inner and outer magnet groups 122 and 126 had flat surfaces as shown in FIGS. 12 and 13. The narrower gap 130 improves the magnetic flux density within the gap 130 and thus improves the efficiency of the electromagnetic lever diaphragm audio transducer 62.

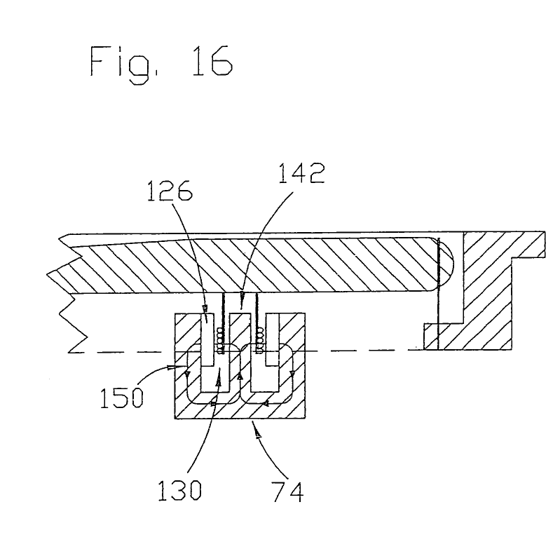

Alternatively, as shown in FIG. 16, the inner magnet group 122 (FIG. 11) may be removed from the magnet box 74. As shown, the center wall 142 of the magnet box 74 does not have an inner magnet group 122 (FIG. 11) mounted thereto, rather the gap 130 is defined only by the outer magnet group 126 and the center wall 142. The center wall 142 is a ferromagnetic return path for the magnetic flux 150 provided by the outer magnet group 126. The magnetic flux 150 in the gap 130 may not be as intense in this magnetic structure, however the embodiment shown in FIG. 16 is cheaper and easier to assemble without the inner magnet group 122 (FIG. 11).

Alternatively, the magnetic structure may be reconfigured such that the permanent magnets are not directly exposed to the voice coil 134. In high power applications, the voice coil receives higher amounts of electrical energy to obtain higher sound pressure level outputs from the speaker. In such situations, the additional electrical input increases the magnetic forces of the voice coil, which are transferred to the diaphragm to create higher sound pressure levels. However, the higher electrical inputs lead to an increase in voice coil temperature. The permanent magnets used in the electromagnetic lever diaphragm transducer 62 may be of the Neodymium type. These magnets are susceptible to damage (demagnetization) by heating them beyond their Curie temperature, at which point the magnets will permanently start to demagnetize. One way to reduce the heat received by the permanent magnets is to move the magnets away from the gap and conduct the magnetic field created by the magnets to the gap through a highly permeable conductor, such as iron, that defines the gap. This way the heat generated by the voice coil within the gap will be received and absorbed by the highly permeable conductor and can be dissipated below the Curie temperature before reaching the permanent magnets. A magnetic structure with a gap defined by a highly permeable material having a magnetic field provided in the gap by conducting the magnetic field from the permanent magnets to the gap through the highly permeable material and thus not directly exposing to the magnets to the voice coil can be easily adapted and employed in the embodiments disclosed herein.

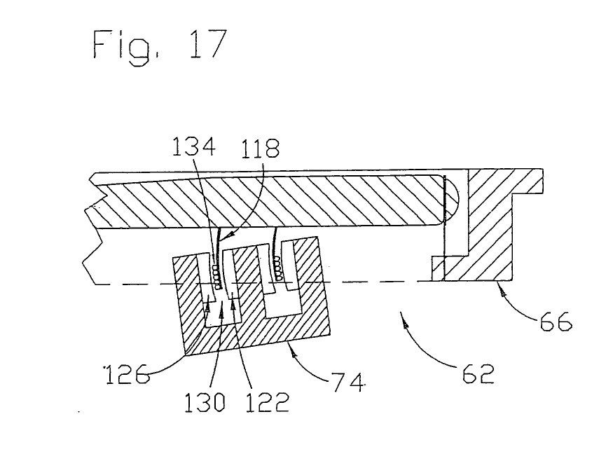

Alternatively, as shown in FIG. 17, the orientation of the magnet box 74 may be altered to allow a better reception of the voice coil 134 of transducer 62. The former 118, voice coil 134, inner and outer magnet groups 122 and 126, and gap 130 are all curved. The magnet box 74 is positioned on the frame 66 at a non-perpendicular angle to the frame 66 such that the magnet box 74 is oriented to better receive the voice coil 134 moving in a radial path. By orienting the magnet box 74 as such relative to the axis of rotation, the mechanical efficiency of the transducer 62 may be improved in the embodiment of FIG. 17.

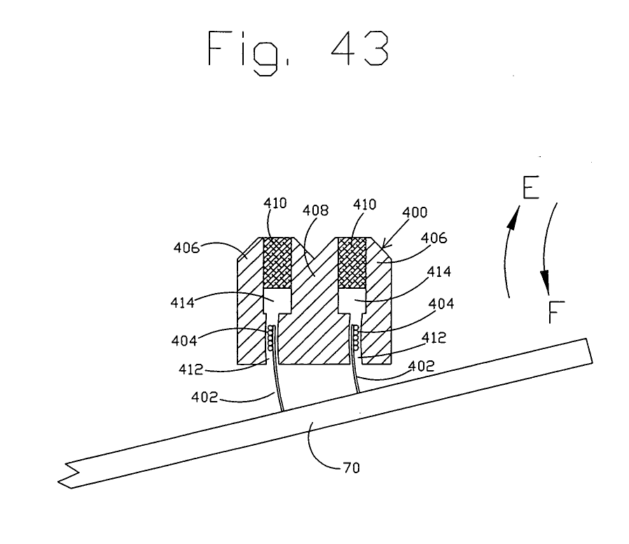

FIG. 43 illustrates a partial cross-sectional side view of an alternative magnet box 400 receiving two curved former sections 402 carrying curved voice coil sections 404 and mounted to a panel 70. The magnet box 400 includes two outer walls 406 and a center section 408. The outer walls 406 and center section 408 are made of a conductive material, such as, by way of example only, iron. The magnet box 400 includes magnets 410 located between the center section 408 and the outer walls 406. The outer walls 406 and the center section 408 define lower gaps 412 that are curved to correspond to and receive the curved former sections 402 and voice coil sections 404. The outer walls 406, center section 408, and magnets 410 define upper gaps 414 that are generally rectangular in shape. When the panel 70 is at rest, the voice coil sections 404 are positioned in the lower gaps 412 between the central section 408 and the outer walls 406 and below the upper gaps 414. In this way, the voice coil sections 404 are not positioned in the upper gaps 414 and proximate the magnets 410 when the panel 70 is at rest, limiting exposure of the magnets 410 to heat generated by the voice coil sections 404.

In operation, the magnets 410 generate a magnetic flux that flows through the outer walls 406, the lower gaps 412, and the center section 408. The voice coil sections 404 receive an alternating current that generates an electromagnetic field in the lower gaps 412. The electromagnetic field reacts with the magnetic flux in the gaps 412 created by the magnets 410 such that the voice coil sections 404 move within the lower gaps 412 in the directions of arrows E and F. As the voice coil sections 404 move in the directions of arrows E and F, the panel 70 moves radially in the directions of arrows E and F. Alternatively, the voice coil sections 404 can move into the upper gaps 414 proximate the magnets 410 while moving in the directions of arrow E. Also, the voice coil sections 404 may be configured to at least partially extend out of the lower gaps 412 (and out of the magnet box 400) and/or extend into the upper gaps 414 (overhang) when the panel is at rest 70.

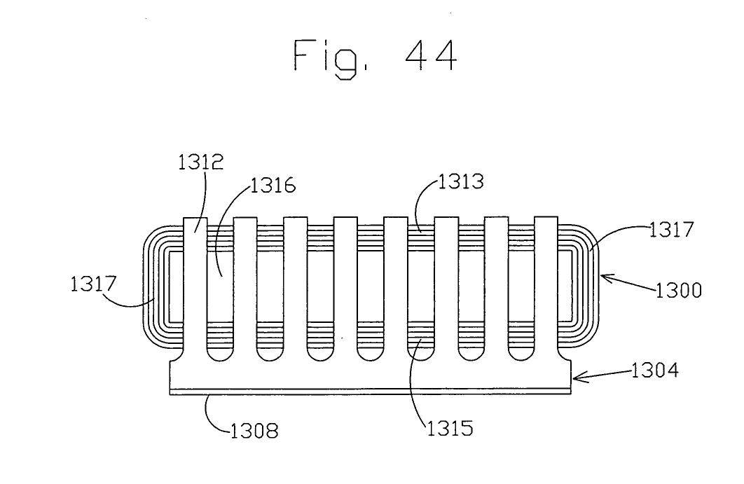

FIG. 44 illustrates a front view of a voice coil 1300 and former 1304. The voice coil 1300 is vertically wound in an “over-under” pattern and connected to the former 1304 along the length of the former 1304 in the general shape of a rectangle with curved corners. The voice coil 1300 has generally parallel upper and lower sections 1313 and 1315 and generally parallel side sections 1317. The side sections 1317 extend outside of the former 1304. The former 1304 may be made of, by way of example only, a rigid material resilient to heat such as fiber glass or carbon fiber. The former 1304 has a base 1308 with vertical fingers 1312 extending therefrom and defining vertical gaps 1316 between the fingers 1312. The upper and lower sections 1313 and 1315 of the voice coil 1300 are generally connected perpendicularly to the fingers 1312. The former 1304 may be flat, curved, and/or extend at an angle with respect to the base 1308. Alternatively, the former 1304 may include a single gap 1316 or a number of gaps 1316.

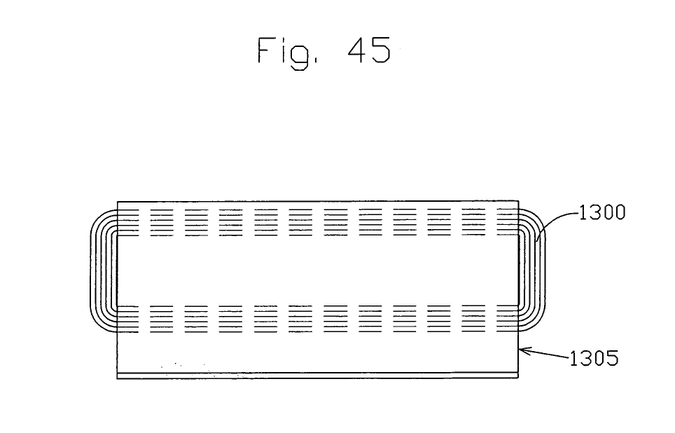

Alternatively, referring to FIG. 45, instead of having fingers 1312 and gaps 1316, the former 1305 may be a generally continuous or generally solid rectangular panel with no gaps 1316, with the upper and lower sections 1313 and 1315 of the voice coil 1300 mounted along the length of the former 1305.

Alternatively, the formers 1304 and 1305 of FIGS. 44 and 45 may have a number of different shaped gaps or arrangement of gaps located therealong. Alternatively, the voice coil 1300 of FIGS. 44 and 45 can be connected to the formers 1304 and 1305 in other configurations and shapes besides the curved rectangular shape and can be connected to the formers 1304 and 1305 as a series of separate voice coils instead of one single voice coil.

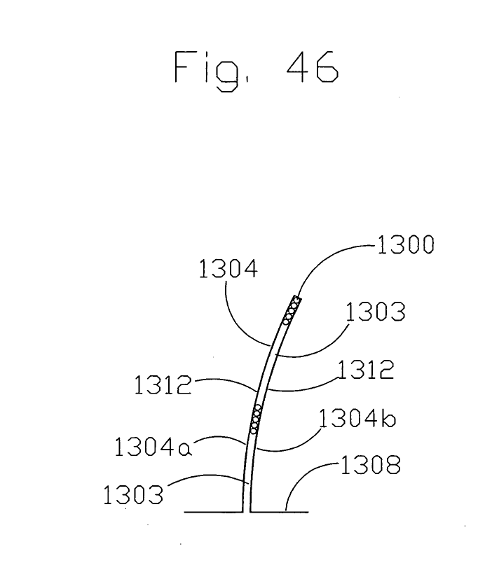

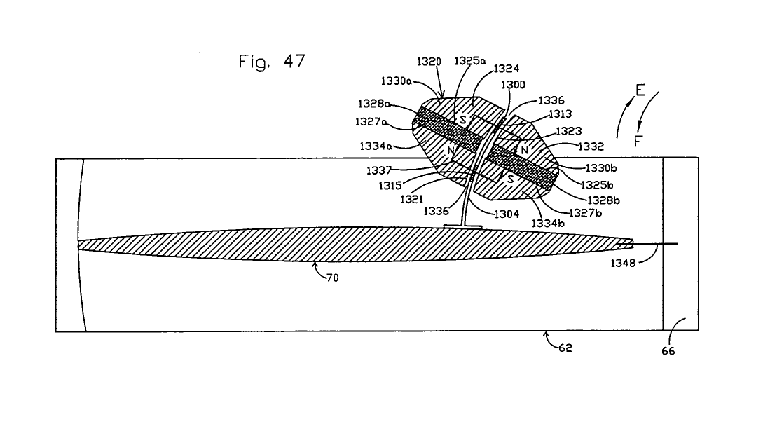

FIG. 46 illustrates a side view assembly of the voice coil 1300 and former 1304 of FIG. 44. The former 1304 has two sides 1304a and 1304b. The fingers 1312 are curved with respect to the flat base 1308. The base 1308 is configured to be mounted to a panel 70 of a transducer 62 (FIG. 47). By way of example only, the voice coil 1300 may be vertically wound “over-under” apart from the former 1304 and then press formed and glued in between the two sides 1304a and 1304b of the former 1304, causing the coil 1300 to conform to the curvature of the fingers 1312 with respect to the base 1308. Having the two sides 1304a and 1304b separated by the thickness of the coil forms a hollow area 1303 in the former 1304, thus reducing the mass of the assembly. The two sides 1304a and 1304b separated by the thickness of the coil 1300 also create a structure that adds stiffness to the assembly. Alternatively, the former 1304 and voice coil 1300 may be flat and generally perpendicular to the base 1308 or may be oriented at an angle with respect to the base 1308. Alternatively, the former 1305 and its corresponding voice coil 1300 of FIG. 45 may be curved, flat, or oriented at an angle with respect to a base.

FIG. 47 illustrates a cross-sectional side view of a transducer 62 including the voice coil 1300 and former 1304 of FIG. 46 mounted to the panel 70. The former 1304 and voice coil 1300 are received in a magnetic box or assembly 1320. The magnetic assembly 1320 is configured to be mounted to the transducer 62 and includes a first wall 1324 opposite a second wall 1332. The first wall 1324 includes a magnet 1328a positioned between an upper portion 1330a and a lower portion 1334a. The second wall 1332 includes a magnet 1328b positioned between an upper portion 1330b and a lower portion 1334b. The magnets 1328a and 1328b extend through the entire width of the first and second walls 1324 and 1332, respectively, such that the upper and lower portions 1330a and 1334a cover upper and lower surface areas 1325a and 1327a, respectively, of the magnet 1328a and that the upper and lower portions 1330b and 1334b cover upper and lower surface areas 1325b and 1327b, respectively, of the magnet 1328b. The upper and lower portions 1330a and 1330b and 1334a and 1334b are made of a conductive material such as, by way of example only, iron. The walls 1324 and 1332 include curved inner surfaces 1321 and 1323, respectively, that define a curved gap 1336 therebetween the walls 1324 and 1332. The gap 1336 receives the voice coil 1300 and former 1304. When the panel 70 is at rest, the upper section 1313 of the voice coil 1300 is positioned between the upper portions 1330a and 1330b of the first and second walls 1324 and 1332 and the lower section 1315 of the voice coil 1300 is positioned between the lower portions 1334a and 1334b of the first and second walls 1324 and 1332. By way of example only, the upper section 1313 can be generally centered along the inner surfaces 1321 and 1323 of the upper portions 1330a and 1330b, respectively, and the lower section 1315 can be generally centered along the inner surfaces 1321 and 1323 of the lower portions 1334a and 1334b, respectively. In this way, the upper and lower sections 1313 and 1315 of the voice coil 1300 are not positioned between the magnets 1328a and 1328b when the panel 70 is at rest, limiting exposure of the magnets 1328a and 1328b to heat generated by the voice coil 1300.

In operation, the magnets 1328a and 1328b generate a magnetic flux 1337 that flows through the gap 1336 between the upper portions 1330a and 1330b of the walls 1324 and 1332 and the lower portions 1334a and 1334b of the walls 1324 and 1332. The polarities of the magnets 1328a and 1328b are positioned in opposite directions such that “North” is along the upper surface area 1325b of magnet 1328b and “North” is along the lower surface area 1327a of magnet 1328a such that the magnetic flux 1337 flows in a counterclockwise path from the magnet 1328b through the upper portion 1330b, the gap 1336, the upper portion 1330a, the magnet 1328a, the lower portion 1334a, the gap 1336, the lower portion 1334b and back to the magnet 1328b. Alternatively, the magnets 1328a and 1328b can be oriented such that the flux 1337 flows the opposite direction. The flux 1337 generated by the magnet 1328a is concentrated as it emanates from the larger surface area 1327a of the magnet 1328a and passes through the lower portion 1334a to the smaller surface area of the inner surface 1321 along the lower portion 1334a into the gap 1336. Likewise, the flux 1337 generated by the magnet 1328b is concentrated as it emanates from the larger surface area 1325b of the magnet 1328b and passes through the upper portion 1330b to the smaller surface area of the inner surface 1323 along the upper portion 1330b into the gap 1336. This concentrating of the flux 1337, along with the oppositely aligned polarities of the magnets 1328a and 1328b, strengthens the flux 1337 across the gap 1336.

The voice coil 1300 receives an alternating current that generates an electromagnetic field in the gap 1336. The electromagnetic field reacts with the magnetic flux 1337 in the gap 1336 such that the upper section 1313 of the voice coil 1300 moves within the gap 1336 in the directions of arrows E and F between the upper portions 1330a and 1330b of the magnetic assembly 1320 and the lower section 1315 of the voice coil 1300 moves within the gap 1336 in the directions of arrows E and F between the lower portions 1334a and 1334b of the magnetic assembly 1320. As the voice coil 1300 moves in the directions of arrows E and F, the panel 70 moves radially with respect to the frame 66 in the directions of arrows E and F about a connection point 1348. The upper and lower sections 1313 and 1315 of the voice coil 1300 may move into the area of the gap 1336 between the magnets 1328a and 1328b while moving in the directions of arrows E and F. The upper section 1313 of the voice coil 1300 may move out of the gap 1336 and above the magnetic assembly 1320 when moving in the direction of Arrow E, and the lower section 1315 of the voice coil 1300 may move out of the gap 1336 and below the magnetic assembly 1320 when moving in the direction of Arrow F.

Alternatively, the upper section 1313 of the voice coil 1300 may be oriented such that it is not generally centered with respect to the inner surface 1323 of the wall portion 1330b, and the lower section 1315 may be oriented such that it is not generally centered with respect to the inner surface 1321 of wall portion 1334a. The upper section 1313 of the voice coil 1300 can be positioned closer to the top of the gap 1336 located between the upper wall portions 1330a and 1330b when the panel 70 is at rest. Likewise the lower section 1315 of the voice coil 1300 can be positioned closer to the bottom of the gap 1336 between the lower wall portions 1334a and 1334b when the panel 70 is at rest. Alternatively, the upper and lower sections 1313 and 1315 of the voice coil 1300 may be oriented such that they partially extend out of the gap 1336 (overhang) above and below the magnetic assembly 1320, respectively, when the panel 70 is at rest. These alternative orientations of the voice coil sections 1313 and 1315 can effect the performance of the transducer 62.

The curvature of the former 1304, voice coil 1300, and gap 1336 accommodates the radial movement of the panel 70 such that the voice coil 1300 is situated generally at the same distance from both the first and second walls 1324 and 1332 as the voice coil 1300 moves along a radial path within the gap 1336. Therefore, the gap 1336 can be narrow and facilitate a strong magnetic flux density within the gap 1336. Alternatively, the first and second walls 1324 and 1332 may define a gap that is only partly curved or that is at least partly straight and arranged at an angle to receive the former 1304 and voice coil 1300.

Furthermore, the slots or gaps 1316 (FIG. 44) in the former 1304 provide venting that allows air to cool the voice coil 1300 when the voice coil 1300 heats up during activation. As electric current flowing through the voice coil 1300 heats up the voice coil 1300, the gaps 1316 allow air to flow across the voice coil 1300 to cool the voice coil 1300 and allow heat to dissipate from the former 1304 and voice coil 1300. Additionally, the slots 1316 in the former 1304 reduce the weight of the former 1304, increasing the efficiency of the transducer 62. Also, the fingers 1312 accommodate expansion of the voice coil 1300 when the voice coil 1300 becomes heated. The fingers 1312 are made of a material such that the fingers 1312 are able to flex laterally with respect to the gaps 1316 as the voice coil 1300 expands due to heating. By way of example only, the fingers 1312 are made of a rigid material resilient to heat such as fiber glass or carbon fiber. By being able to move laterally with the expansion of the voice coil 1300, the fingers 1312 help maintain the original shape of the voice coil 1300, and thus help prevent the voice coil 1300 and former 1304 from warping and rubbing the inner surfaces 1321 and 1323 (FIG. 47) of the gap 1336 as the panel 70 rotates.

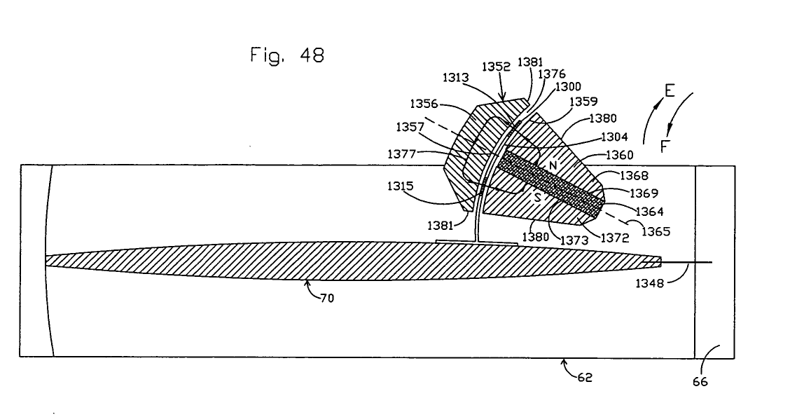

FIG. 48 illustrates a cross-sectional side view of a transducer 62 including the voice coil 1300 and former 1304 of FIG. 46 mounted to a panel 70. The former and 1304 and voice coil 1300 are received in a magnetic assembly or box 1352. The magnetic assembly 1352 includes a first wall 1356 opposite a second wall 1360. The first wall 1356 does not include a magnet, and the second wall 1360 does include a magnet 1364 positioned between an upper portion 1368 and a lower portion 1372. The magnet 1364 extends through the entire width of the second wall 1360 such that the upper and lower portions 1368 and 1372 cover upper and lower surface areas 1369 and 1373, respectively, of the magnet 1364. The first wall 1356 and the upper and lower portions 1368 and 1372 are made of a conductive material such as, by way of example only, iron. The walls 1356 and 1360 include curved inner surfaces 1357 and 1359, respectively, that define a curved gap 1376 therebetween that receives the voice coil 1300 and former 1304. When the panel 70 is at rest, the upper section 1313 of the voice coil 1300 is positioned between the first wall 1356 and the upper portion 1368 of the second wall 1360 and the lower section 1315 of the voice coil 1300 is positioned between the first wall 1356 and the lower portion 1372 of the second wall 1360. In this way, the upper and lower sections 1313 and 1315 of the voice coil 1300 are not positioned across from the magnet 1364 when the panel 70 is at rest, limiting exposure of the magnet 1364 to heat generated by the voice coil 1300.

In operation, the magnet 1364 generates a magnetic flux 1377 that, because of the polarity of the magnet 1364, flows counterclockwise through the upper portion 1368, the gap 1376, the first wall 1356, back through the gap 1376, and through the lower portion 1372 back to the magnet 1364. Alternatively, the polarity of the magnet 1364 can be oriented such that the flux 1377 flows in a different direction. The flux 1377 generated by the magnet 1364 is concentrated as it emanates from the larger upper surface area 1369 of the magnet 1364 and passes through the upper portion 1360 to the smaller surface area of the inner surface 1359 along the upper portion 1360 into the gap 1376. The single magnet 1364 is larger than the magnets 1328 of the transducer 62 of FIG. 47 and has more surface area exposed to the upper and lower portions 1368 and 1372 than the magnets 1328. Therefore, the magnetic lines of flux 1377 generated in the magnetic assembly 1352 can be more densely packed in the gap 1376 than the magnetic lines of flux 1337 packed in the gap 1336 generated by the magnetic assembly 1320 of FIG. 47. Additionally, the upper portion 1368 and the lower portion 1372 of the second wall 1360 have outer walls 1380 that are angled with respect to the upper surface 1369 and lower surface 1373 of the magnet 1364. The angles of the outer walls 1380 can be based on the estimated convergence point of the two outer walls 1380 at an apex aligned approximately with the center of the curvature of the former 1304 along axis 1365. The angles of the outer walls 1380 are maintained along outer walls 1381 of the first wall 1356 as well. In this way the flux 1377 in the gap 1376 can generally be maintained perpendicular to the radial movement of the voice coil 1300. This alignment of the flux 1377 with the voice coil 1300 helps increase the efficiency of the transducer 62.

The voice coil 1300 receives an alternating current that generates an electromagnetic field in the gap 1376. The electromagnetic field reacts with the magnetic flux 1377 in the gap 1376 created by the magnet 1364 such that the upper section 1313 of the voice coil 1300 moves within the gap 1376 in the directions of arrows E and F between the first wall 1356 and the upper portion 1368 of the second wall 1360 and the lower section 1315 of the voice coil 1300 moves within the gap 1376 in the directions of arrows E and F between the first wall 1356 and the lower portion 1372 of the second wall 1360. As the voice coil 1300 moves in the directions of arrows E and F, the panel 70 moves radially with respect to the frame 66 in the directions of arrows E and F about a connection point 1348. The upper and lower portions 1313 and 1315 of the voice coil 1300 may move into the area of the gap 1376 between the first wall 1356 and the magnet 1364 while moving in the directions of arrows E and F. The upper section 1313 of the voice coil 1300 may move out of the gap 1376 and above the magnetic assembly 1352 when moving in the direction of Arrow E, and the lower section 1315 of the voice coil 1300 may move out of the gap 1376 and below the magnetic assembly 1352 when moving in the direction of Arrow F.

Alternatively, the upper and lower sections 1313 and 1315 of the voice coil 1300 may be oriented such that they are not generally centered with respect to the inner surface 1359 of the upper portion 1368 and the lower portion 1372, respectively. The upper section 1313 of voice coil 1300 can be positioned closer to the top of gap 1376 located between the first wall 1356 and upper portion 1368 of the second wall 1360 when the panel 70 is at rest. Likewise the lower section 1315 of voice coil 1300 can be positioned closer to the bottom of gap 1376 located between the first wall 1356 and lower portion 1372 of the second wall 1360 when the panel 70 is at rest. Alternatively, the upper and lower sections 1313 and 1315 of the voice coil 1300 may be oriented such that they partially extend out of the gap 1376 (overhang) above and below the magnetic assembly 1352, respectively, when the panel 70 is at rest. By having the voice coil sections 1313 and 1315 not generally centered and even extending them out of the gap above and below the magnetic assembly 1352, the performance of the transducer 62 can be affected. Alternatively, the first and second walls 1356 and 1360 may define a gap that is only partly curved or that is at least partly straight and arranged at an angle to receive the former 1304 and voice coil 1300.

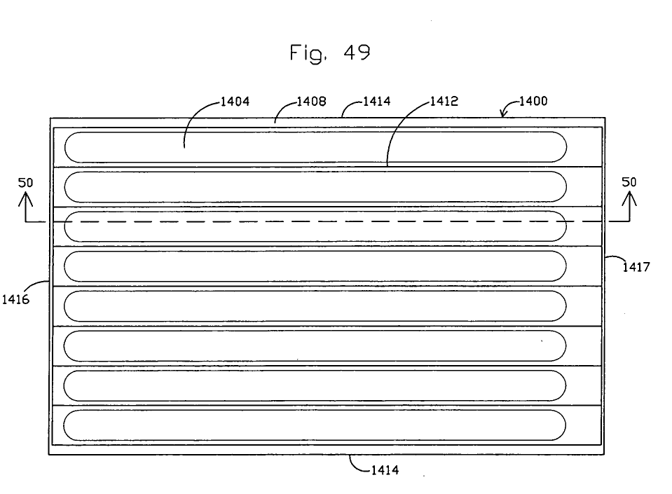

FIG. 49 illustrates a bottom view of an alternative diaphragm or panel 1400 that can be used with an electromagnetic transducer 62 (FIGS. 5-11) or other kinds of transducers. The panel 1400 is generally rectangular in shape and includes a series of longitudinal grooves 1404 extending along a bottom surface 1408 of the panel 1400. Alternatively, the panel 1400 can have other shapes so as to fit in a speaker or frame. The panel 1400 is configured to be connected to a former and voice coil of a transducer 62 and rotated within a frame to generate sound waves. The panel 1400 is made of, by way of example only, a rigid foam and can include carbon fiber or any other high-tensile-strength fiber bound by epoxy and positioned in sections 1412 between the grooves 1404 and along the sides 1414 and ends 1416 and 1417 of the panel 1400.

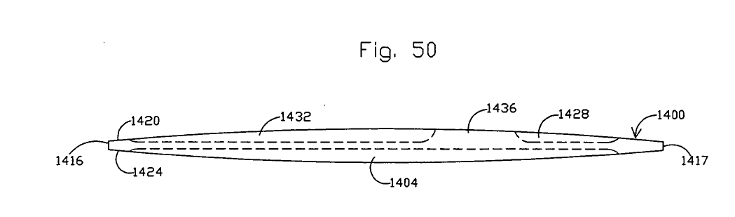

FIG. 50 illustrates a cross-sectional side view of the panel 1400 of FIG. 49 taken along line 50-50. The panel 1400 includes a top side 1420 and a bottom side 1424 each having a convex curve to form narrow tips at the ends 1416 and 1417 of the panel 1400. Alternatively, the panel 1400 may be flat on one or both sides, curved or tapered on one or both sides, or be angled on one or both sides, or include a number of other contours or combination of contours on the top and bottom sides 1420 and 1424. The panel 1400 includes the grooves 1404 extending into the bottom side 1424, and also includes additional short grooves 1428 and long grooves 1432 extending into the top side 1420. The short grooves 1428 and long grooves 1432 are separated by a full section 1436, upon which a former and voice coil can be mounted. Alternatively, a former and/or voice coil can be mounted to the panel 1400 across or on top of the grooves. The end 1417 can be connected to a frame, baffle or speaker to rotate at the connection. Alternatively, the panel 1400 may have grooves along only one of the top and bottom sides 1420 and 1424 thereof, or may have grooves having a number of different sizes, shapes, and depths along either of the top and bottom sides 1420 and 1424.

The grooves on each side of the panel 1400 reduce the mass and volume of the panel 1400 while the convex-curved shape of each side of the panel can help maintain the stiffness of the panel 1400. The application of the carbon fiber and epoxy can further strengthens the panel 1400 while adding little extra mass. Therefore, the panel 1400 can be more efficient to operate than panels without grooves while still displacing air to generate sound.

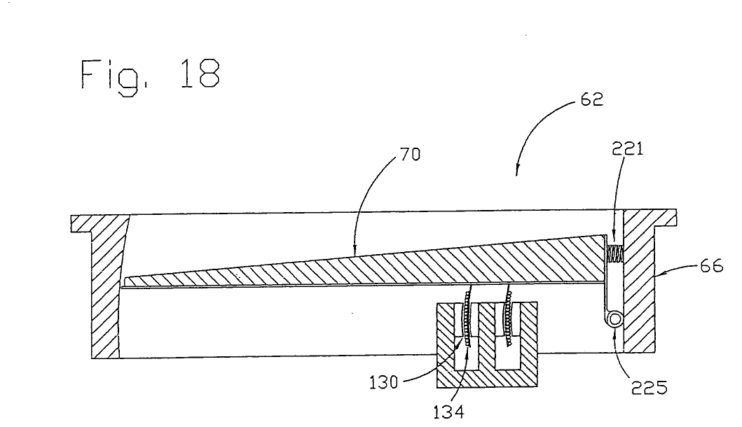

Alternatively, as shown in FIG. 18, an “overhung” voice coil 134 can be used with the electromagnetic audio transducer 62. The voice coil 134 extends out of the gap 130 when the voice coil 134 is in the rest position. By extending the length of the voice coil 134, the panel 70 is able to rotate even greater distances while a portion of the voice coil 134 stays within the gap 130. Because the voice coil 134 is larger and extends out of the gap 130, the voice coil 134 dissipates more electrical power as heat and thus may be less efficient. However, the loss in efficiency is offset by an increase in the low frequency performance of the transducer 62 due to the increase in the volume of air the panel 70 displaces by being able to travel a greater distance. Also, the panel 70 may be rotatably connected or coupled to the frame 66 by a bearing, bushing, or hinge 225 and a spring 221 instead of by a flexible strip. The spring 221 resists the rotation of the panel 70 and applies pressure to the panel 70 to maintain the panel 70 and voice coil 134 in a center position when at a rest position as shown in FIG. 18.

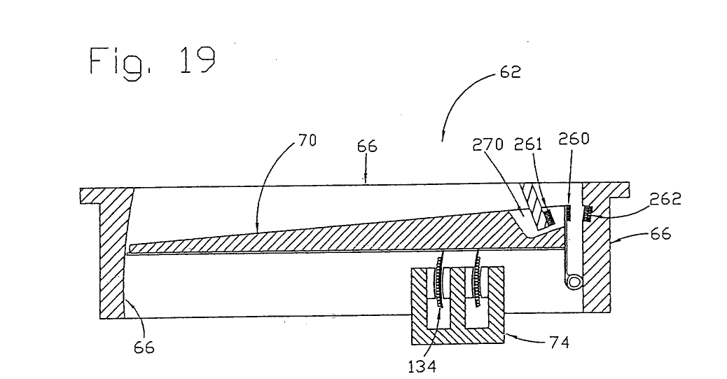

Alternatively, the transducer 62 shown in FIG. 19, has the spring 221 (FIG. 18) removed and replaced by another type of suspension system. Here a magnet 260 or a plurality of magnets 260 are attached to the panel 70. Another corresponding group of magnets 261 and 262 are fixed to the frame 66. Panel 70 may have grooves 270 to provide clearance for the magnet group 261. The orientation of the poles of the magnets are such that magnet 260 is repulsed by both magnets in the group 261 and 262. Magnet 260 will be repulsed such that it will be maintained at an equal distance between magnet group 261 and 262. In operation, when the panel 70 is rotated about its axis in either direction, the magnet 260 will move closer to either magnet group 261 or 262. As the magnet 260 moves closer to either magnet group 261 or 262, the repulsion force between the magnets will increase like the compressing of a spring. This repulsing force will resist the movement of the panel 70, and when the panel 70 is not rotating the magnet 260 will be pushed into a centering, equidistant position between the magnet groups 261 and 262 to return the panel 70 and voice coil 134 to a centered rest position. The advantage with a magnetic suspension system is that there are no parts to wear out. Also, in different operating temperatures, the magnetic repulsion forces are more stable than spring materials that tend to get stiffer as temperatures decrease. For example, in conventional speaker systems, the suspension system of surrounds and spiders tends to become stiff in low temperatures and change the operating characteristics of the speaker. Also, the surround and spiders tend to become loose and wear out over time. Alternately, the magnet group 260 may be located at different positions on the panel 70 and the magnet group 261 and 262 may be correspondingly located at different positions on the frame 66 or magnet box 74. The advantage in having the magnet group 260 located in the position as shown in FIG. 19 is that the moment of inertia of the magnet 260 is kept to a minimum.

In an alternative embodiment, the panel 70 of FIG. 11 may be coupled to the opposite first and second members 101 and 103 (FIG. 6) of the side wall 82 of the frame 66 by a coupling of at least a pin or axle and bearing that is located between the tip end 90 and the pivot end 86. The panel 70 may rotate within the frame 66 along a rotational axis about the coupling. In such an orientation, the pivot end 86 and tip end 90 of the panel 70 are both free to move radially, in a “see-saw” fashion within the frame 66. Also, a voice coil 134 may be coupled to the panel 70 on either or both sides of the pin and bearing and a magnet box 74, may be directly or indirectly connected to the frame 66 on either or both sides of the pin and bearing to receive the voice coil 134 to move the panel 70.

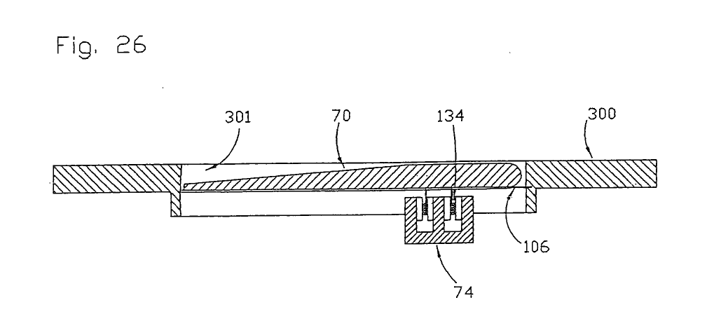

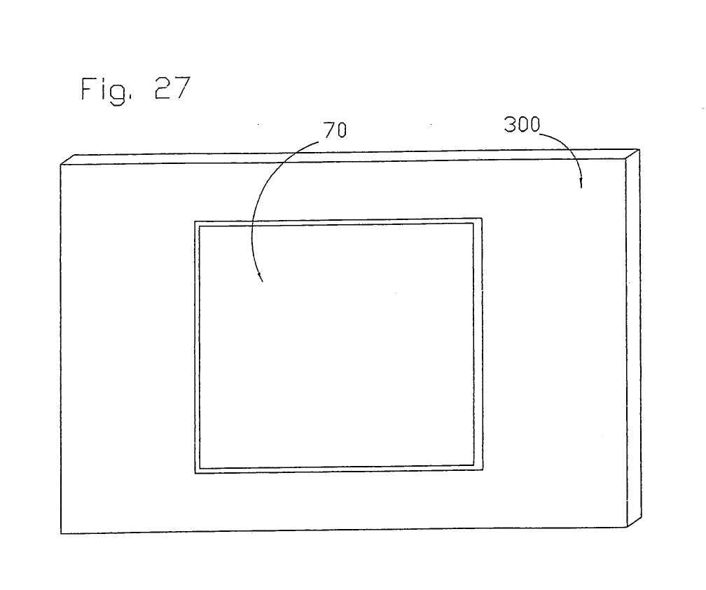

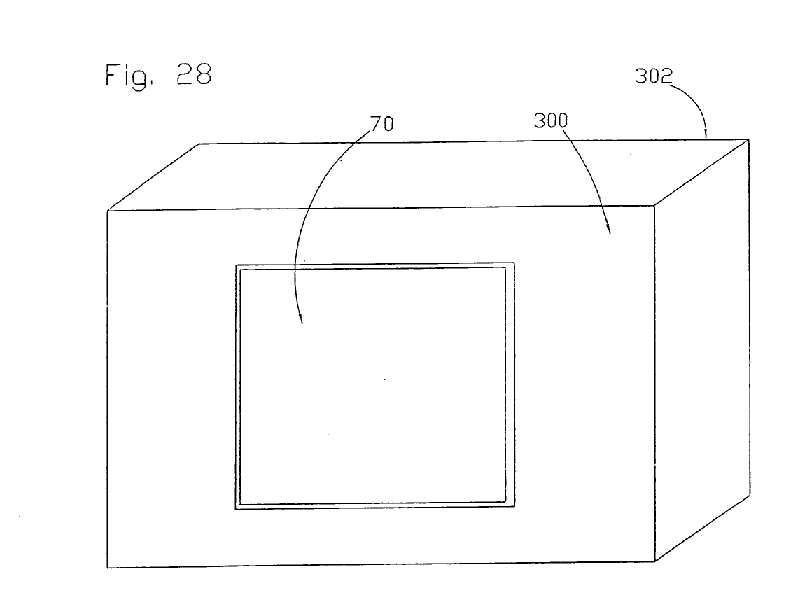

Alternatively, as shown in FIGS. 26 and 27, the panel 70 may be disposed within an aperture 301 of a baffle 300. The baffle 300 is a partition that prevents interference between sound waves. A magnet box 74 may be mounted to the baffle 300 to engage the coil 134 coupled to the panel 70, and thus serve as an actuator, to rotate the panel 70 relative to the baffle 300. The panel 70 is suspended within the aperture 301 by coupling the panel 70 to the baffle 300 with a thin flexible material 106. The coupling provides an axis for rotation of the panel 70. Alternatively, any of the other methods described herein for coupling the panel 70 to a frame to rotate the panel 70 such as a bearing or axle, or centering via a spring or magnetics may be employed to suspend the panel 70 within the baffle 300. The panel 70 rotates and operates within the enclosed baffle 300 in the same way it operates within the frame 66 of FIG. 5. Alternatively, more than one panel 70 and actuator mechanism 74 may be mounted into a single baffle 300. Alternatively, the panel 70 may be disposed within an aperture of a baffle 300 of an enclosed hollow box 302 as shown in FIG. 28. The hollow box 302 may be an enclosure or a speaker box and may be any number of shapes.

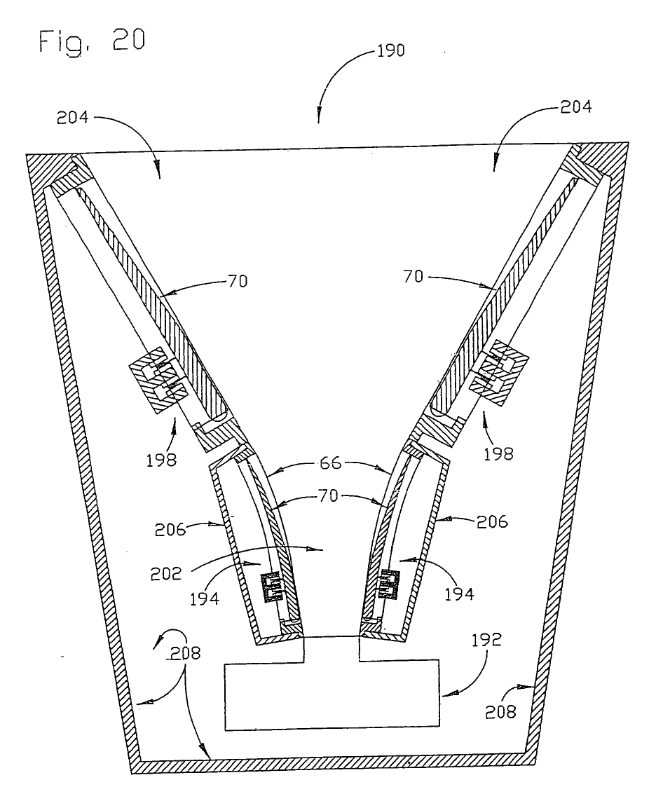

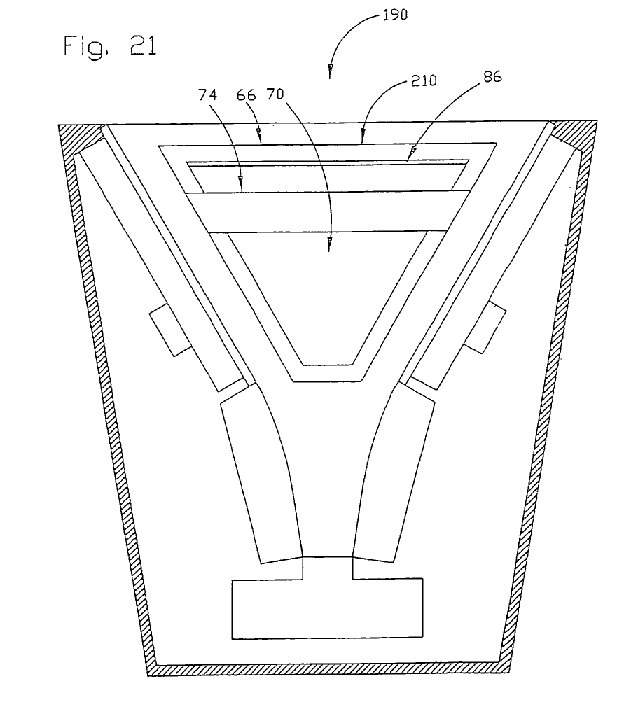

Often, multiple audio transducers are combined together on a single horn where each transducer emits a different frequency range of sound waves into the horn and the sound waves are acoustically combined together before exiting the horn into free air space. Such transducer-horn arrangements serve to match the impedance of the acoustic load of the air to each audio transducer and to direct and set the path of the sound waves produced within the horn by the multiple audio transducers. As shown in FIGS. 20 and 21, multiple audio transducers that produce sound in different frequency ranges are combined together to define a horn and create a horn-speaker system assembly 190 with a full range of sound. FIG. 20 illustrates a top cross-sectional view of a speaker system assembly 190 using at least one conventional high-frequency device 192 (shown not as a cross-sectional view, but as a whole view), and mid-frequency and low-frequency electromagnetic lever diaphragm audio transducers 194 and 198 mounted in the enclosure 208 such that a horn is created with a throat section 202 and a mouth section 204. The panels 70 of the low-frequency transducers 198 are planar and tapered. The enclosure 208 captures and contains the sound pressures from the back side of panels 70 of the transducers 198. Likewise the enclosure 206 capture and contain the sound pressures from the back sides of panels 70 of the transducers 194 and also provide a barrier from the low frequency sound pressures of transducers 198. The high frequency device 192, or driver, generates high frequency audio sound pressure waves.

The panels 70 and frames 66 of the mid-frequency transducers 194 may be curved to better accommodate the flare rate of the horn at the throat section 202 for the high-frequency driver 192. The curvature of the panels 70 and frames 66 of the mid-frequency transducers 194 also provides a minimally obstructive wave-guide path for the high frequency sound waves emanating from the high frequency driver 192. For example, high frequency sound waves emitted from the driver 192 pass along, and are directed by, the smooth curved panels 70 of the mid-frequency transducers 194 with minimal interference. Even with the panels 70 of the mid-frequency transducers 194 reciprocating from peak to peak during operation, the shape and position of the panels 70 interfere very little with the main path of the high frequency sound waves emanating from the driver 192. Similarly, the tapered panels 70 of the low-frequency transducers 198 interfere very little with the sound waves emitted from the high frequency driver 192 and the mid-frequency transducers 194. Alternatively, the speaker system 190 is not limited to use with a conventional high frequency driver 192. For example, another electromagnetic lever diaphragm audio transducer may be adapted to be used as a high frequency driver in the speaker system 190.

Walls make up the solid boundaries of a horn system and create a path for directing sound waves produced by transducers in conjunction with the horn out of the horn into free air space. The walls also set up an impedance matching function for the transducers. The panels 70 of the electromagnetic lever diaphragm audio transducers 194 and 198 can easily be adapted into a horn where the panels 70 are solid boundaries for directing sound waves produced by other transducers in the horn system. Additionally, the panels 70 radiate their own range of sound frequencies into the horn. The panels 70 of the electromagnetic lever diaphragm audio transducers 194 and 198 of the speaker system 190 become integral active walls of the horn. By using the electromagnetic lever diaphragm audio transducers 194 and 198 as integral active walls of the horn, the speaker system 190 can be smaller and lighter than conventional speaker systems. Alternatively, the orientation of the transducers 194 or 198 in the speaker system 190 may be arranged such that the pivot end and the driver associated with each transducer are positioned nearer the mouth 204 of the horn. The tip ends of the panels 70, which have the greatest radial movement, are nearer the throat 202 of the horn. This arrangement of the transducers may improve the impedance matching of the speaker system 190.

Alternatively, as shown in FIG. 21, the speaker system 190 may include an additional electromagnetic lever diaphragm audio transducer 210 with a trapezoidal shaped panel 70 and frame 66 mounted in the top of the horn of the speaker system 190. Alternatively, another electromagnetic lever diaphragm audio transducer with a trapezoidal shaped panel 70 and frame 66 may be mounted in the bottom of the horn of speaker system 190. The additional electromagnetic lever diaphragm audio transducer 210 increases the sound intensity level of the range of frequencies they are producing in the horn before being radiated out of the speaker system 190. As shown, the magnet box 74 and pivot end 86 is positioned at the wider end of the trapezoidal frame 66 to receive the voice coil 134 (not shown) on the trapezoidal panel 70. Alternatively, the magnet box 74 and pivot end 86 may be positioned at the narrow end of the trapezoidal frame 66 to receive the voice coil 134 (not shown) on the trapezoidal panel 70.

Alternatively, the electromagnetic lever diaphragm audio transducer 210 may have any number of other shapes to accommodate the shape of a speaker system. By way of example only, the electromagnetic lever diaphragm audio transducer 210, and its panel 70 and frame 66, may be shaped like a square, rectangle, triangle, semi-circle, or any other shape suitable for use with a speaker system. Furthermore, the voice coil 134 and magnet box 74 may be positioned at different locations and orientations on the panel 70 and frame 66, respectively, to rotate the panel 70 about the rotational axis.

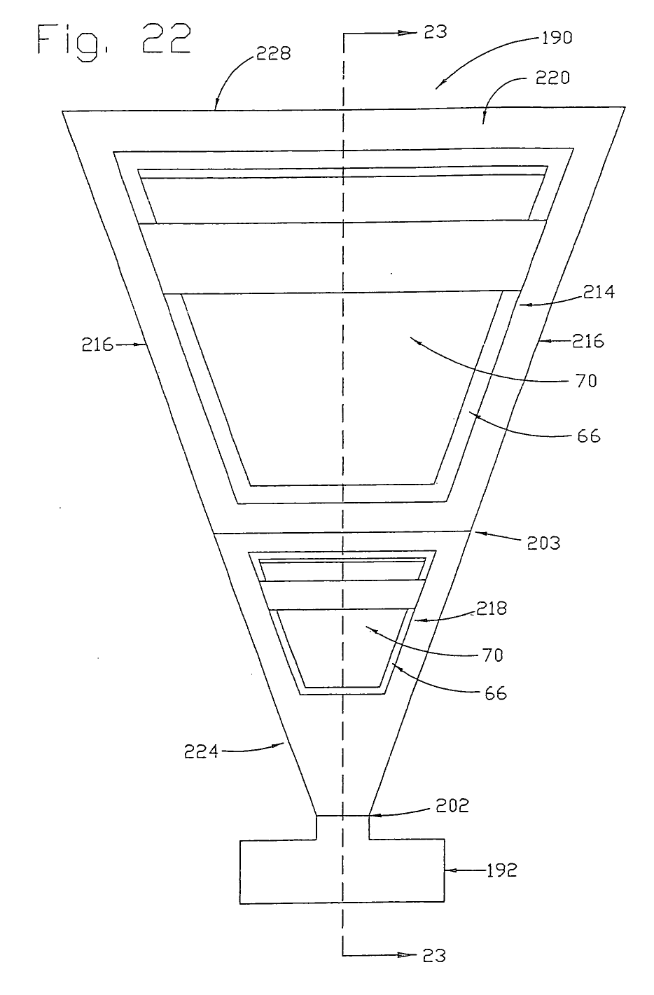

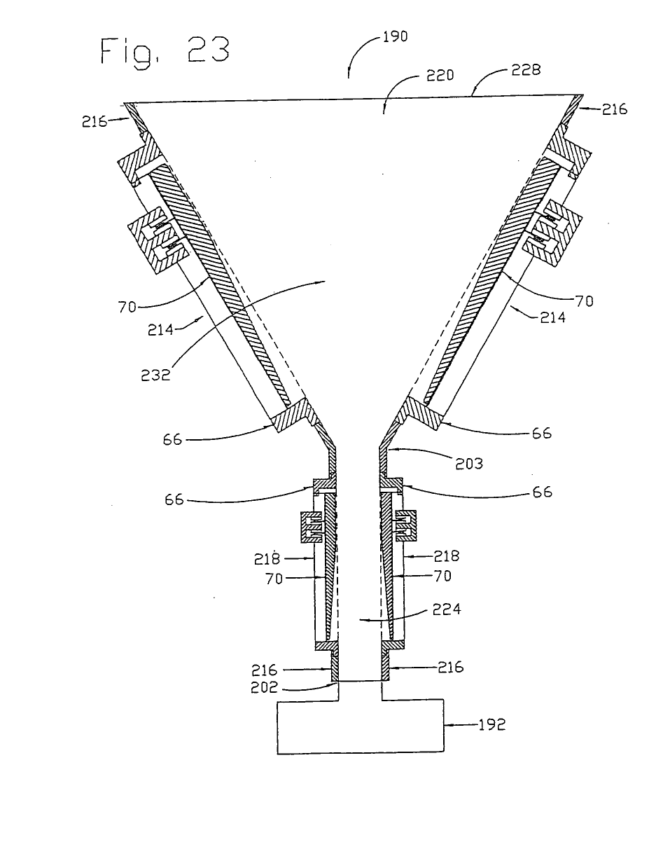

Alternatively, a generally trapezoidal shaped transducer panel or diaphragm may be used in other embodiments. FIGS. 22 through 25 show horn-speaker systems without the pneumatically sealing enclosures of 206 and 208 as shown in FIG. 20. In operation, the enclosures 206 and 208 can be adapted for use with the working systems as depicted in FIGS. 22 through 25. FIGS. 22 and 23 show a speaker system 190 having a series of trapezoidal walls 216 connected together at the edges to form the boundaries of a horn 220. The horn 220 has a vertical flaring section 224 beginning at the throat 202 of the driver 192 that extends to a mouth 228 of the horn 220. Referring to the top view of FIG. 23, a horizontal flare begins at point 203 and is maintained to the mouth 228 of the horn 220. This final flaring section 232 (or bell of the horn) dictates a constant directivity angle of the horn 220 for exiting sound waves produced within the horn 220 by the audio transducers.

Referring to FIG. 22, a low-frequency electromagnetic lever diaphragm audio transducer 214 and a mid-frequency electromagnetic lever diaphragm audio transducer 218, each having a trapezoidal shaped panel 70, may be mounted in a wall 216 of the horn 220. Referring to FIG. 23, the transducers 214 and 218 with the trapezoidal panels 70 may be mounted in opposite walls 216 of the horn 220. The low-frequency transducers 214 are mounted opposite each other along the bell 232 of the horn 220 between point 203 of the horn 220 and the mouth 228. Similarly, the mid-frequency transducers 218 are mounted opposite each other between the throat 202 and the point 203 on the horn 220. The trapezoidal shaped panel 70 and frame 66 of each transducer 214 and 218 allow the transducers 214 and 218 to be used within the flared shape of the horn 220. Alternatively, the horn 220 may include any number of electromagnetic lever diaphragm audio transducers with a trapezoidal panel 70 in each wall 216 in the horn 220.

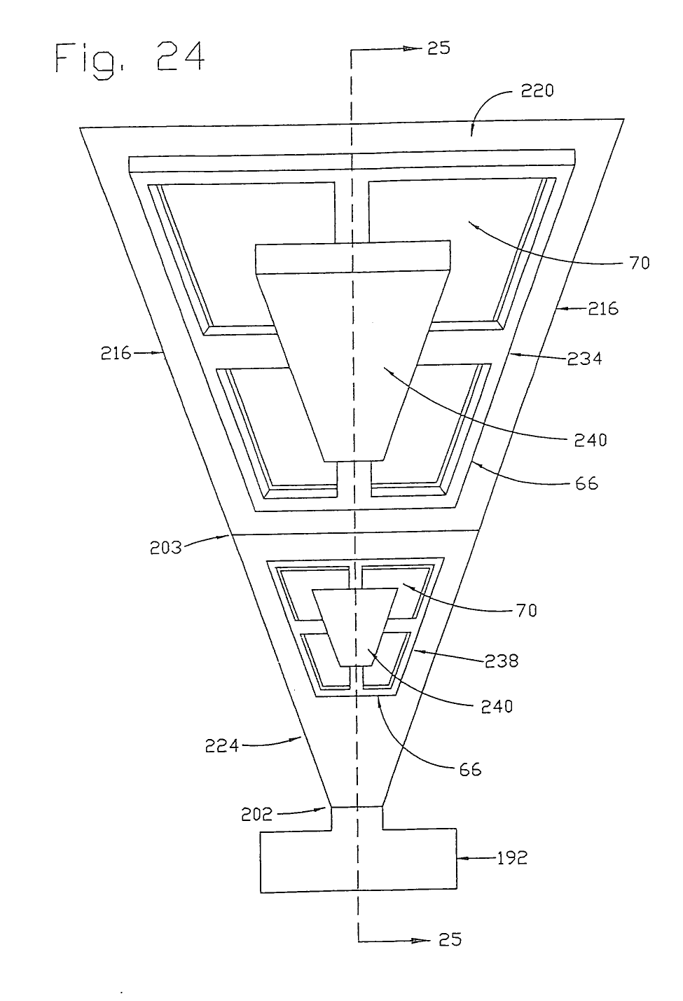

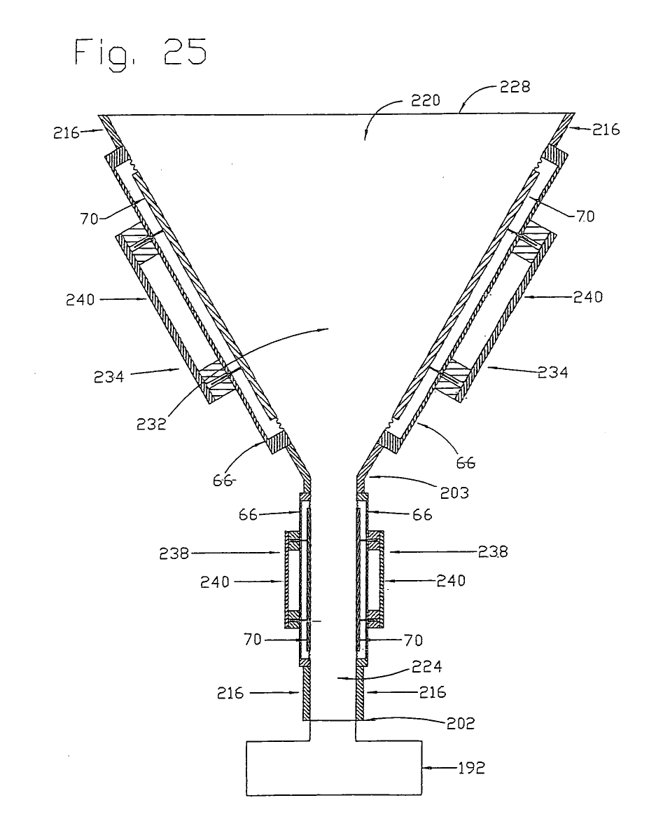

Alternatively, the trapezoidal panel 70 may be used with a conventional axial-reciprocating transducer in a horn arrangement. FIGS. 24 and 25 illustrate a horn 220 similar to that shown in FIGS. 22 and 23 except that the transducers are axial-reciprocating flat panel low and mid-frequency audio transducers 234 and 238 instead of electromagnetic lever diaphragm audio transducers. Referring to FIG. 24, the low-frequency transducer 234 and the mid-frequency transducer 238, each having a trapezoidal shaped panel 70 connected to an axial-driving driver system 240, may be mounted in a wall 216 of the horn 220. Referring to FIG. 25, the transducers 234 and 238 with the trapezoidal panels 70 may be mounted in opposite walls 216 of the horn 220. The low-frequency transducers 234 are mounted opposite each other along the bell 232 of the horn 220 between the point 203 of the horn 220 and the mouth 228. Similarly, the mid-frequency transducers 238 are mounted opposite each other along the vertical flare 224 between the throat 202 and the point 203 on the horn 220. The trapezoidal shaped panel 70 and frame 66 of the transducers 234 and 238 allow the transducers 234 and 238 to be used within the flared shape of the horn 220. Alternatively, the horn 220 may include any number of conventional axial-reciprocating flat panel audio transducers with a trapezoidal panel 70 in each wall 216 in the horn 220.

The trapezoidal shape of the panels 70 and frames 66 of FIGS. 22-25 allow the transducers 214, 218, 234, and 238 to be used in speaker-horn arrangements whereby they provide several benefits over conventional round shaped transducers. The trapezoidal panels 70 use most of the space along the horn walls 216 and provide continuity to the angled horn walls 216 so as not to disrupt the sound wave path of each other transducer within the horn 220. The trapezoidal panels 70 also are not just static horn wall boundaries, but serve as integral active horn wall boundaries. In other words, besides serving as a wave guide for each other transducer, each panel 70 also produces its own sound waves across a range of frequencies.

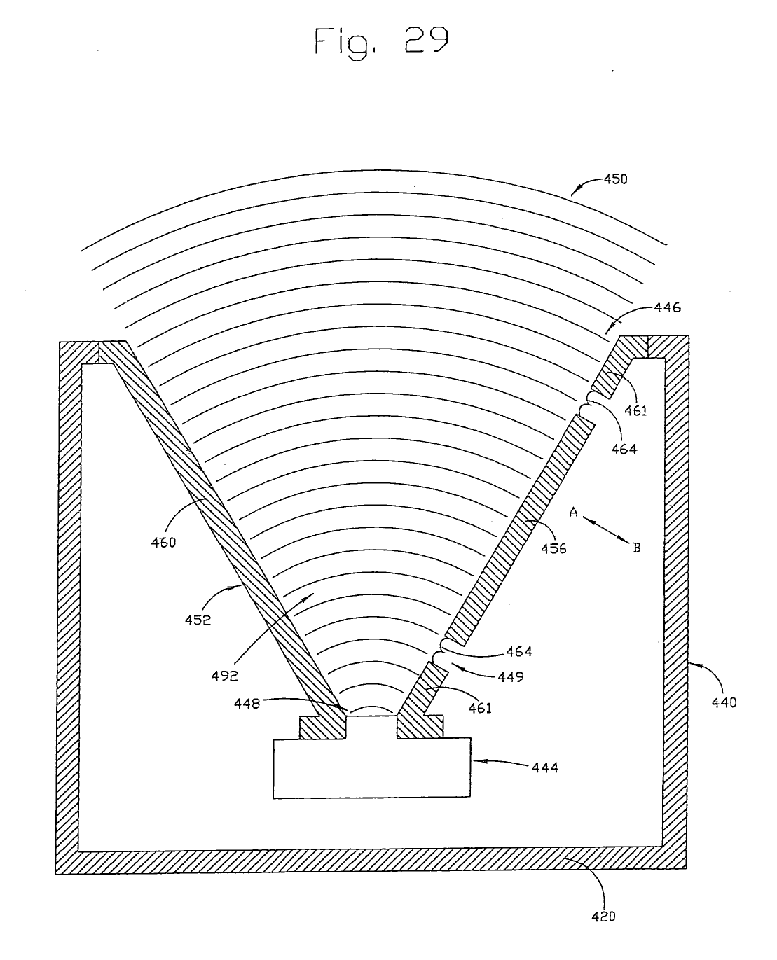

FIG. 29 illustrates a cutaway top view of a speaker system 440 according to another embodiment of the reciprocating wall horn panels speakers shown in FIGS. 24-25. The speaker system 440 includes an audio device 444 located at the apex 448 of a horn 452 that generates sound waves 450. The horn 452 has straight walls 460 and 461 that extend at an angle from the device 444 to a mouth 446 to define a cavity 492. When the sound waves 450 leave the horn 452, the waves 450 propagate outward generally at the same angle set by the horn walls 460 and 461. The walls 460 and 461 and device 444 are located inside a box 420. The horn walls 460 and 461 form boundaries that constrain and guide the sound waves 450 emitted from the device 444. A panel or section 456 of one of the horn walls 461 is separate from the rest of the wall 461 and is maintained within a hole 449 in the wall 461. The section 456 is maintained within, and connected to, the wall 461 by a suspension system 464, which allows the section 456 to move freely generally in the directions of arrows A and B with respect to the wall 461. By way of example only, the horn wall 461 and section 456 may be made of any material that is rigid and light weight. The surfaces of the horn walls 460 and 461 and section 456 exposed along the cavity 492 of the horn 452 are generally smooth. The section 456 is generally flush with the wall 461 when stationary and the section 456 and wall 461 provide a generally smooth, uninterrupted surface. The suspension system 464 may be made of any flexible and/or stretchable material. The suspended section 456 is a part of the horn wall 461 that provides a boundary, like the other walls 460 and 461 of the horn 452, to guide the sound waves 450 out of the horn 452.

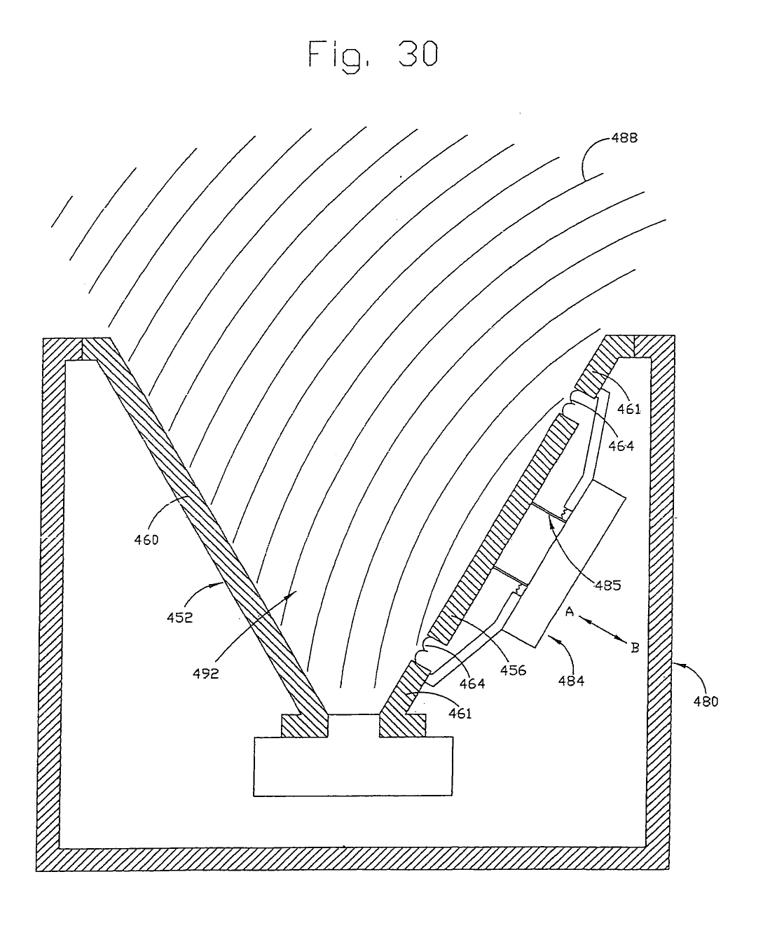

FIG. 30 illustrates a cutaway top view of a speaker system 480 according to an embodiment of the present invention. The speaker system 480 is similar to that shown in FIG. 29 but includes an axial driver 484 mounted to the wall 461 and aligned with the wall section or panel 456 and connected to the panel 456 by a former or connecting piece 485. When an alternating electrical signal is applied to the driver 484, the driver 484 converts the electrical signal into physical motion. This motion is transmitted through the connecting piece 485 to move, and cause to vibrate, the suspended section 456 generally in the directions of arrows A and B according to the electrical signal. The suspension system 464 allows the section 456 to vibrate with respect to the wall 461 while still keeping the section 456 connected to the wall 461. Thus, when the driver 484 receives electrical signals, the section 456 will radiate energy in the form of sound waves 488 into the cavity 492 of the horn 452. Even when the horn wall section 456 is vibrating, it is still a part of the horn wall 461 and provides a boundary, like the other walls 460 in the horn 452, to guide the sound waves 450 (FIG. 29) out of the horn 452. This suspended horn wall section 456 is therefore actively functioning as both a wave guide and as a radiator emitting its own sound waves 488. Because the horn wall section 456 is coupled to a driver 484 that causes the section 456 to vibrate, the section 456 serves as an “active wall” of the horn 452.

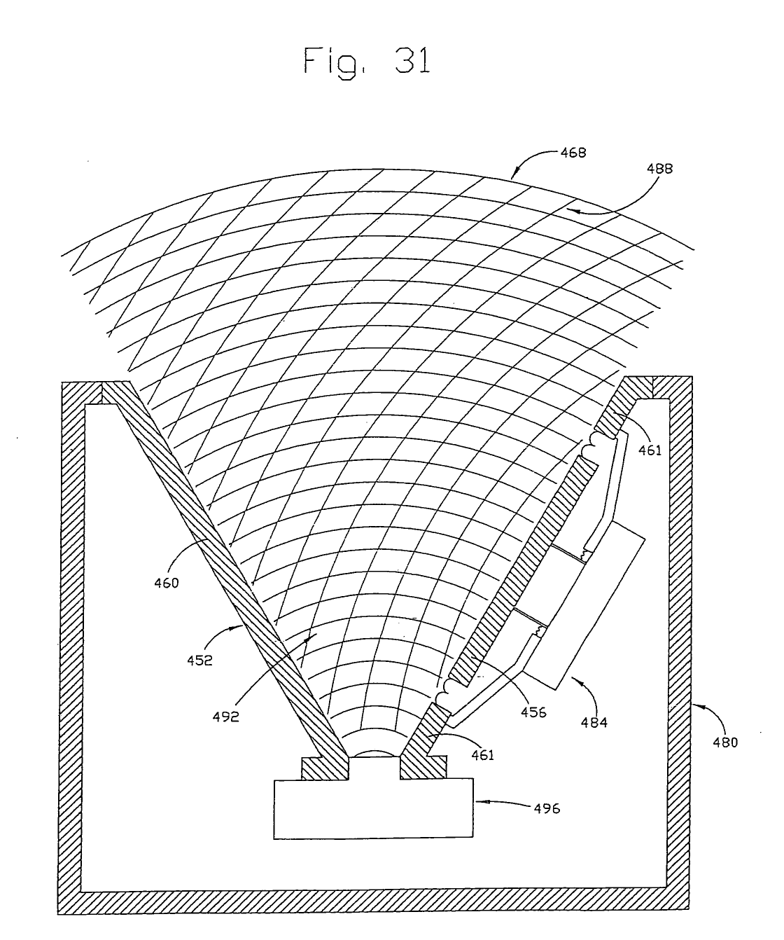

FIG. 31 illustrates the speaker system 480 of FIG. 30 with a high frequency driver 496 emitting sound waves 468. The high frequency driver 496 receives high frequency signals and the driver 484 coupled to the suspended horn wall section 456 receives low frequency signals. The high and low frequency sounds produced by the drivers 496 and 484, respectively, in response to the signals recombine within the horn cavity 492 and exit the horn 452 as a complete audio signal. The high frequencies emitted from the high frequency driver 496 are guided by the horn walls 460 and 461, including the active horn wall section 456. Because the horn walls 460 and 461 generally do not disrupt the path or flow of the high frequency sound waves 468, the waves 468 travel generally smoothly through the horn 452. The driver 484 causes the suspended horn wall section 456 to also actively emit sound waves 488 into the horn cavity 492. The active horn wall section 456 therefore serves both as a horn wall guiding sound waves 468 while at the same time emitting its own sound waves 488 into the horn 452.

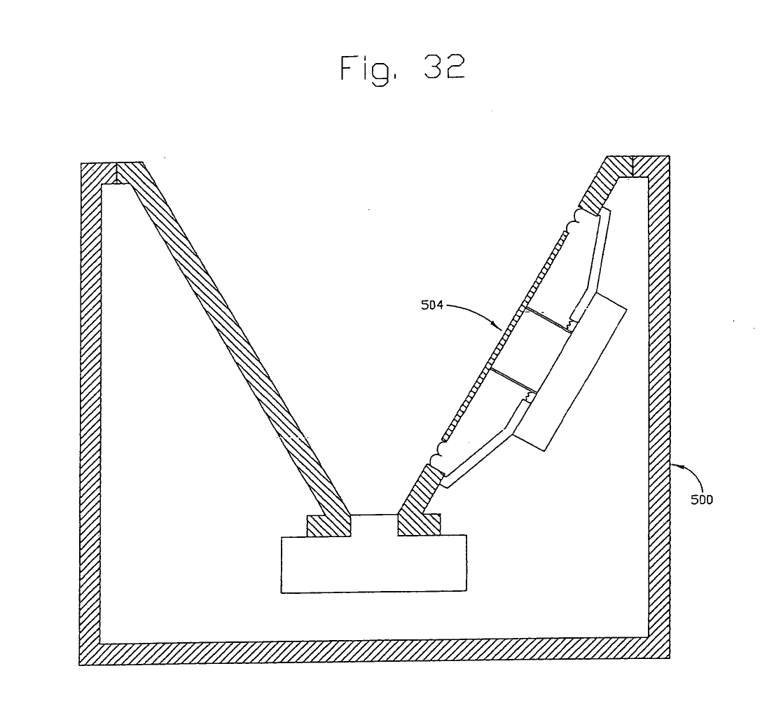

FIG. 32 illustrates a cutaway top view of a speaker system 500 according to an embodiment of the present invention. The system 500 is similar to the one shown in FIGS. 30 and 31, except that the suspended horn wall section 504 is made of a material having a lower mass and/or density than the section 456 and the wall 461 of FIGS. 30 and 31. The section 504 may be thinner than the section 456 and/or the wall 461 and may be made of a lighter-weight but rigid material, such as aluminum clad honey comb composite or a rigid foam and carbon fiber composite, that is different than the material that the horn wall 461 is made of. By making the section 504 lower in mass, the efficiency of the section 504 in producing sound is improved because less energy is required to cause the section 504 to vibrate.

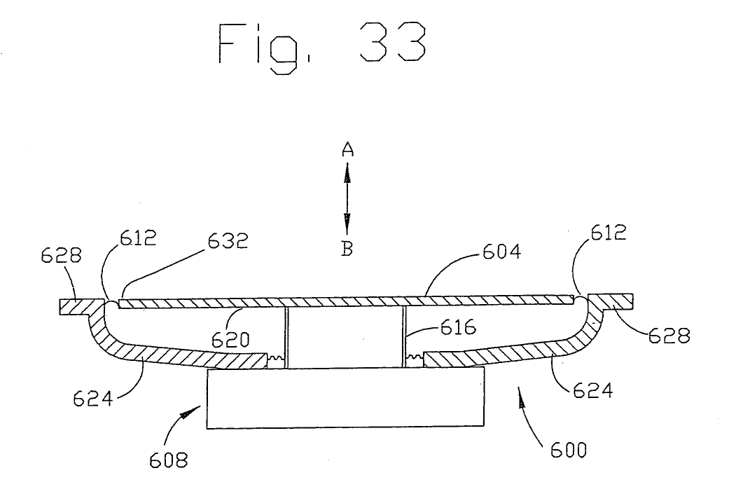

FIG. 33 illustrates a partially cutaway side view of a speaker 600 according to an embodiment of the present invention. The speaker 600 is a self-contained version of the section 456, suspension system 464 and axial driver 484 shown in FIGS. 30-32. The speaker 600 includes a flat wall panel section 604 connected to a driver 608 (driver 608 not in a cutaway view) by a suspension system 612 that allows the section 604 to move generally in the direction of arrows A and B with respect to the driver 608. The driver 608 includes a former 616 that is connected to a backside 620 of the section 604 and a back frame 624 that extends around the section 604 and that includes a peripheral frame 628. The suspension system 612 interconnects peripheral edges 632 of the section 604 to the frame of the back frame 624. The peripheral frame 628 of the speaker 600 allows the speaker to be inserted into pre-made holes in a horn wall such that the frame 628 may be directly connected to the horn wall in order that the speaker 600 is mounted in the hole in the horn wall. The self-contained speaker 600 therefore may be easily manufactured for later installation into a horn wall instead of separately having to install the flat panel section 604 to a horn wall.

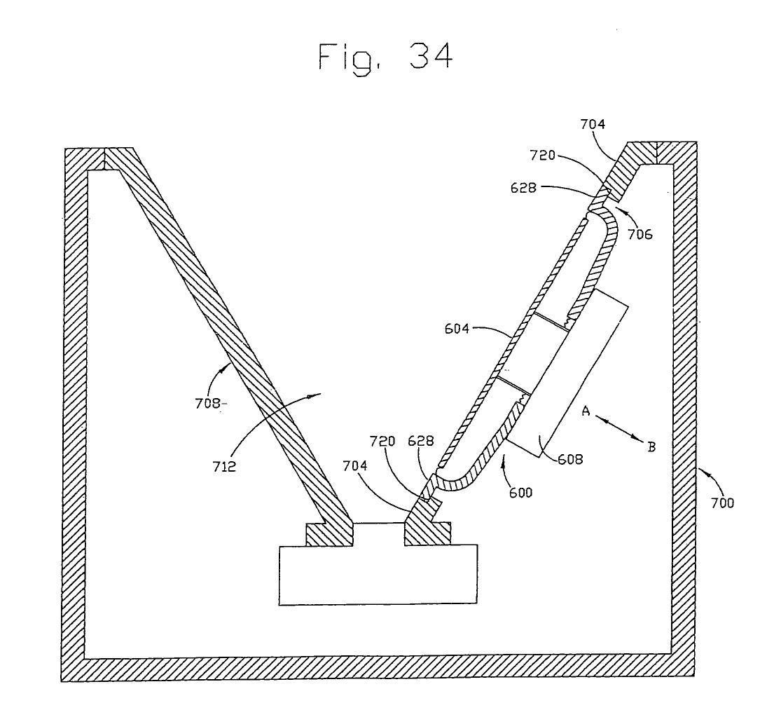

FIG. 34 illustrates a cutaway top view of a speaker system 700 including the speaker 600 of FIG. 33. The speaker 600 is mounted directly in a preformed hole 706 in a wall 704 of a horn 708 and maintains a generally smooth horn wall 704 surface. The frame 628 of the speaker 600 is received along a ledge 720 extending from the wall 704 along the hole 706 such that the frame 628 is generally flush with the wall 704. The frame 628 may be secured to the ledge 720 and wall 704 by any number of fastening methods, including, by way of example only, clamps, fasteners, or pressure fitting. When the speaker 600 is mounted in the wall 704 of the horn 708, the panel section 604 becomes a continuation of the horn wall 704 and functions as part of the horn wall 704. The section 604 of the speaker 600 operates similarly to the active suspended wall sections of FIGS. 30-32. The section 604 is an active wall that operates as both a wave guide along the wall 704 and as a radiator emitting its own sound waves into the horn cavity 712 of horn 708 when the driver 608 causes the section 604 to vibrate generally in the directions of arrows A and B. The wall section 604 may be made of any number of materials, such as a rigid foam and carbon fiber composite or aluminum clad honey comb composite, and may or may not be made of the same material as the horn wall 704.

In an alternative embodiment, the active wall section and driver shown in FIGS. 30-34 may be suspended within, or mounted to, or connected to, a horn wall by any number of other methods that allow the wall section to both serve as a wave guide and generate sound waves.

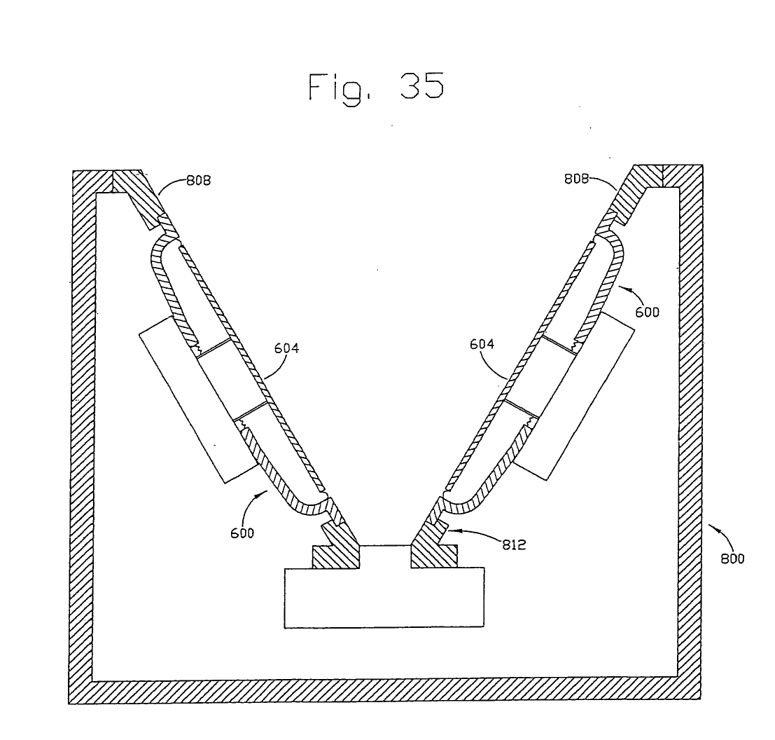

Referring to FIG. 35, a speaker system 800 may include speakers 600 with active wall sections 604, such as the one shown in FIG. 34, on multiple horn walls 808 and may be mounted on horn walls 808 opposite each other within the horn 812.

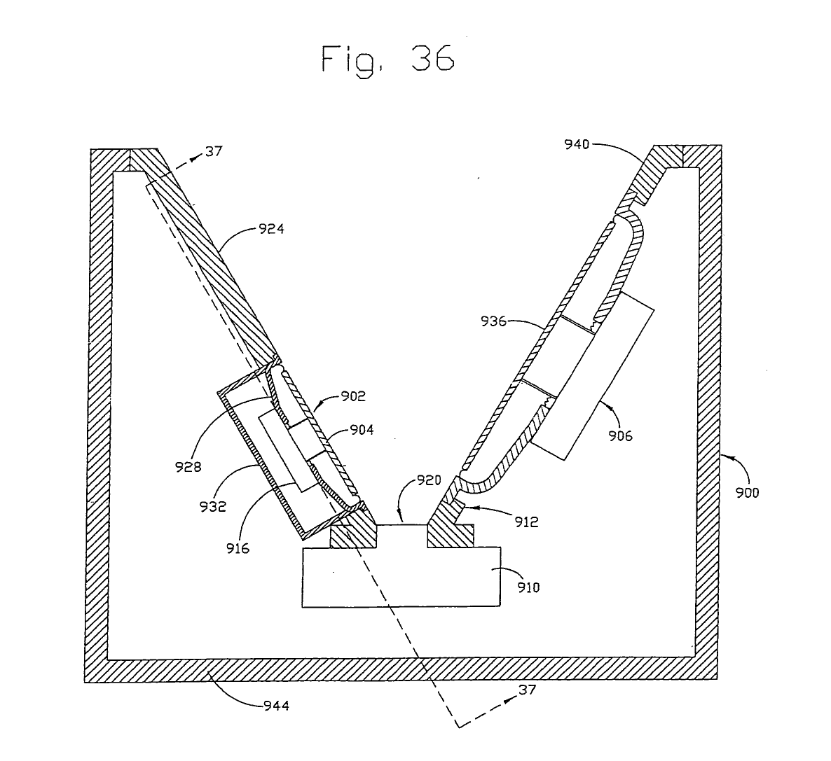

Referring to FIG. 36, a speaker system 900 may include speakers 600 (FIG. 35) with active wall sections of varying sizes on the same horn wall or on separate horn walls. The active wall sections may vary in size in order to radiate a certain range of sound frequencies into the horn 912. For example, the high frequency driver 910 is a contained unit with the back of the diaphragm sealed and the throat of the driver located at the apex 920 of the horn 912. A mid-frequency speaker 902 with a radiating active wall 904 is positioned in a first horn wall 924 with a rear frame 928 enclosed within an isolator box 932 to isolate the mid-frequency driver 916 from a larger low frequency speaker unit 906 mounted in an opposite horn wall 940 within the system box 944. The isolator box 932 prevents the back sound pressure produced from the low frequency active wall 936 from interfering with the mid frequency active wall 904. Both active walls 936 and 904 guide sound waves within the horn 912 as well. The isolator box 932 may be integral with the speaker unit 902 or may be detachably connected to the speaker unit 902. Likewise, the speaker unit 906 may include an isolator box that is integral with the speaker unit 906 or that may be detachably connected to the speaker unit 906. Alternatively, the speaker system 900 may include more than two speaker units mounted in a horn wall or may have both a mid frequency speaker unit 902 and a low frequency speaker unit 906 mounted in each wall of the horn 912.

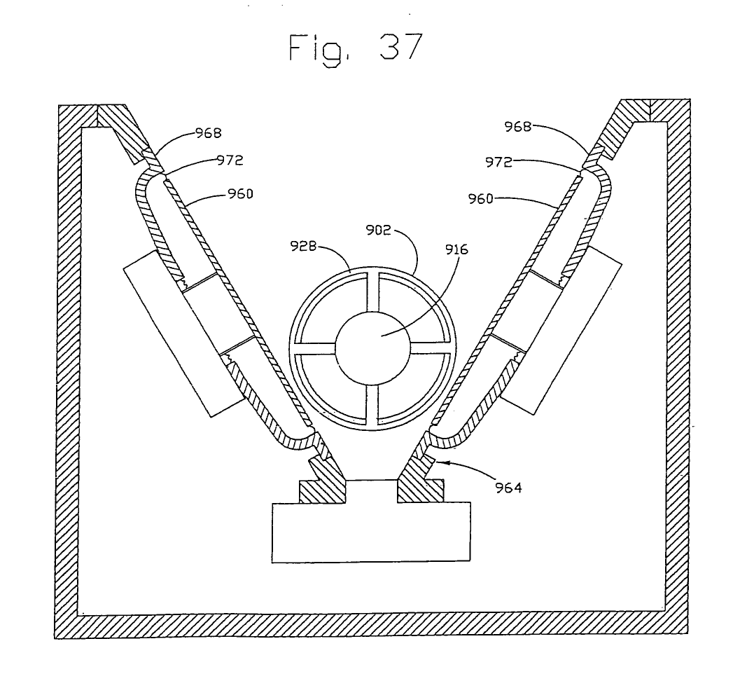

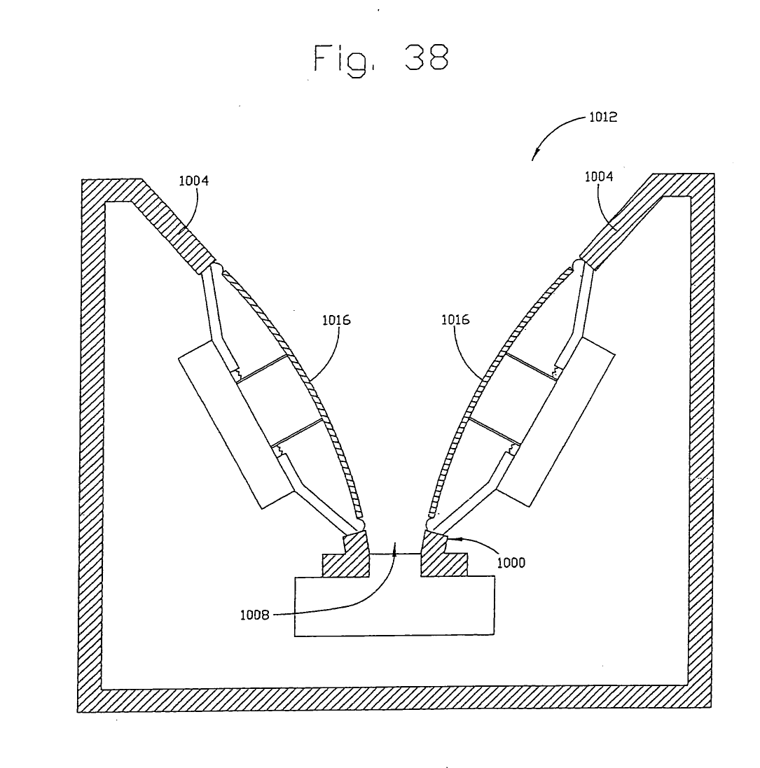

FIG. 37 is a cutaway view of the speaker system 900 of FIG. 36 taken along section lines 37-37. As shown in FIG. 37, any combination of size and location of the active horn walls may be implemented for the specific design criterion of a particular horn. The rear of the frame 928 and driver 916 of speaker 902 are shown. The speaker wall 936 of FIG. 36 is not shown in FIG. 37. On opposite sides of speaker 902 are active horn walls 960. The active horn walls 960, and their corresponding frames 968 and suspension systems 972, may have any number of different shapes, sizes, and/or contours as necessary to fit a particular horn shape or geometry. For example, referring to FIG. 38, the horn 1000 has walls 1004 that curve from the apex 1008 to the mouth 1012 of the horn 1000. The active walls 1016 are likewise curved to fit within the walls 1004. The active horn walls 1016 may be completely curved, or partially straight and partially curved, or any other combination of shapes that fits the shape of the horn walls 1004.

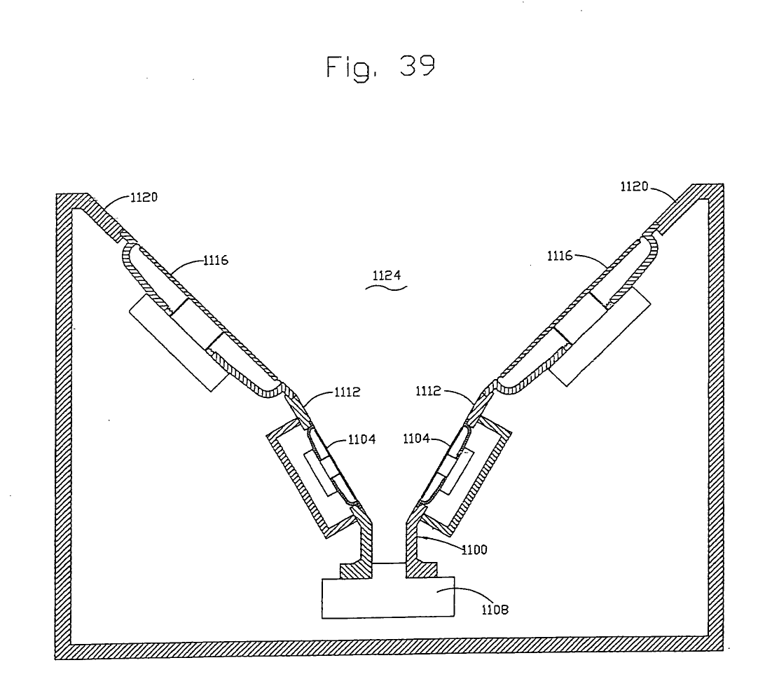

Referring to FIG. 39, the speaker horn 1100 includes active horn walls of different sizes placed in different locations. Horn wall geometries with two or more wall angles may be used to improve the directivity of sound waves as they are emitted out of the horn and into free air space. Therefore, mid frequency active walls 1104 guide the waves of the high frequency driver 1108 along inner horn walls 1112 oriented at a first angle to the driver 1108 while low frequency active walls 1116 guide the waves of both the high and mid frequencies along outer horn walls 1120 oriented at a second angle to the driver 1108. All the active walls 1104 and 1116 radiate sound waves into the horn cavity 1124 while also serving as waveguides for other sound waves passing through the cavity 1124.

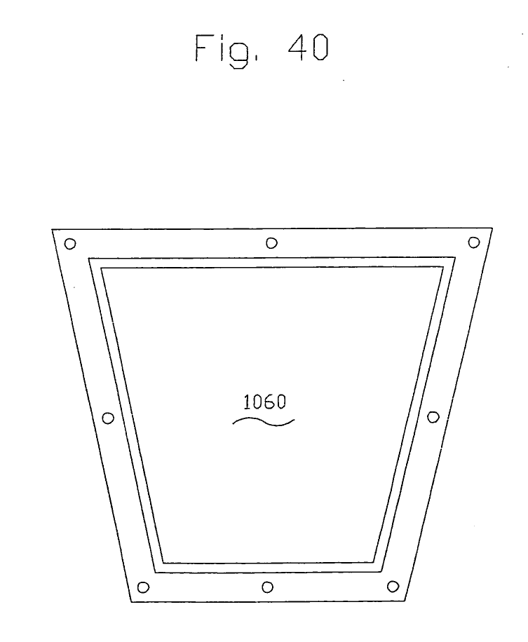

Referring to FIG. 40, the active wall of the various embodiments of FIGS. 30-39 may be trapezoid in shape to best fill the horn wall. A trapezoid shaped active horn wall 1060 may be used with a horn because the side wall of a horn is often trapezoidal in shape and therefore a trapezoidal horn wall 1060 would fill up almost the entire area of the trapezoidal horn side wall and reduce the size of the speaker box housing the horn. The active wall of the various embodiments, however, may be any number of other shapes that best fit in a particular horn. By way of example only, the active wall may be square, round, oval, rectangular or rhomboid in shape.

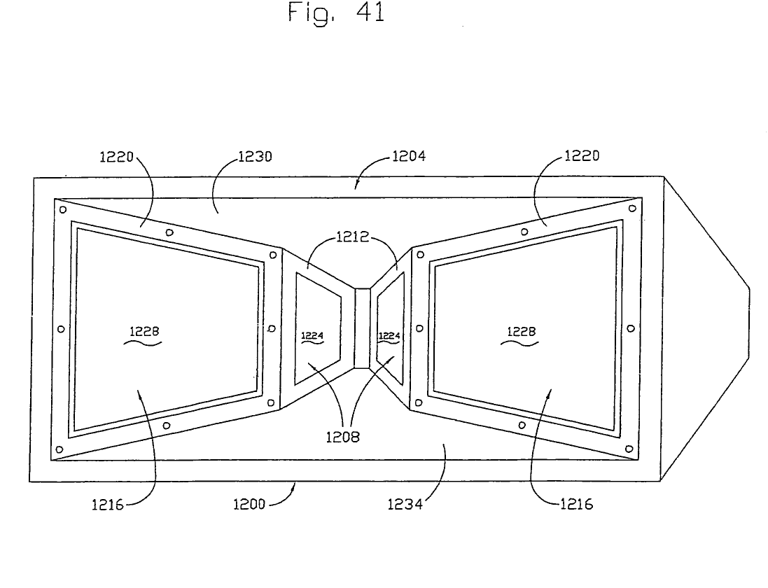

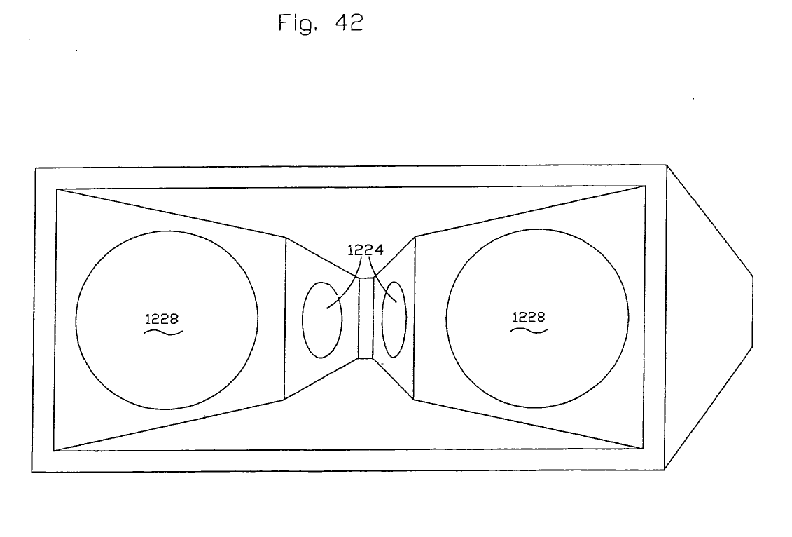

FIG. 41 illustrates a front view of a speaker system 1200 according to an embodiment of the present invention. The speaker system 1200 has a horn 1204 that includes two differently sized trapezoid-shaped active horn wall speakers. The horn 1204 includes mid-frequency active wall speakers 1208 along inner side walls 1212 of the horn 1204 and low-frequency active wall speakers 1216 along outer side walls 1220 of the horn 1204. The speakers 1208 and 1216 operate similarly to the active wall speakers shown in FIGS. 30-39. The active wall panels 1224 of the speakers 1208 fill most of the inner walls 1212 and the active wall panels 1228 of the speakers 1216 fill most of the outer walls 1220. Alternatively, the upper and lower walls 1230 and 1234 of the horn 1204 may also include active wall speakers mounted therein and having active wall panels that are generally the same shape as the upper and lower walls 1230 and 1234. Alternatively, as shown in FIG. 42, the active wall panels 1224 and 1228 of the system 1200 may be round.

Alternatively, any of the above-described embodiments may be combined and interchanged in any number of ways to result in an embodiment that suits the needs for a particular speaker system.

The different embodiments of the electromagnetic lever diaphragm audio transducer provide numerous benefits and improvements over conventional axial-reciprocating audio transducers. First, as discussed earlier, the movement of the lever diaphragm or panel is not tied to the movement of the voice coil by a 1:1 ratio. Rather, because of the lever design of the diaphragm in the transducer, the tip end of the panel moves a greater distance than the voice coil. Thus, the diaphragm panel can displace more air than a conventional axial-reciprocating cone style speaker while maintaining the voice coil in the gap. Therefore, the electromagnetic lever diaphragm audio transducer can receive higher electrical input signals at lower frequencies to produce a higher level sound intensity without creating distortion or sacrificing efficiency. The problems associated with axial-reciprocating cone style audio transducers as described in the prior art are reduced by the electromagnetic lever diaphragm audio transducer.

Second, the lever diaphragm and associated parts in the electromagnetic lever diaphragm audio transducer experience less adverse inertial effects during movement than do the similar moving parts in conventional audio transducers. The total masses associated with the moving parts of conventional axially-reciprocating audio transducers are in a fixed relationship to the inertial forces opposing their movement. The inertial forces encountered by the moving parts in the electromagnetic lever diaphragm audio transducer of the present invention are a function of their masses in relation to their distance from the pivot end, or fulcrum, of the lever diaphragm panel. For example, the high-mass voice coil is positioned close to the pivot end to reduce the moment of inertia of the voice coil. Conversely, while the tip end of the panel is furthest away from the fulcrum and thus has the largest moment, the tip end also has low mass such that it will create only a limited amount of inertia on the moving panel. By being able to reduce inertial forces by maintaining the high mass components of the electromagnetic lever diaphragm audio transducer close to the fulcrum, the electromagnetic lever diaphragm audio transducer is more efficient than conventional transducers. Also, by this method of limiting the moment of the voice coil to reduce the effects of inertia, larger, more powerful voice coils can be used in the electromagnetic lever diaphragm audio transducer to receive larger electrical inputs to create higher sound level outputs without a significant increase in inertia.

The lever design of the electromagnetic lever diaphragm audio transducer also allows for a stronger, more robust suspension system without increasing inertial effects on the movement of the diaphragm or panel. The fulcrum of the electromagnetic lever diaphragm audio transducer is located at the axis of rotation and therefore can be made of heavy, strong materials without significantly increasing inertia on the moving panel. Therefore, the suspension system of the electromagnetic lever diaphragm audio transducer can be made much stronger than the suspension systems of conventional axially-reciprocating audio transducers without creating additional inertia on the diaphragm of the transducer.

The lever design of the electromagnetic lever diaphragm audio transducer further improves on conventional transducers by eliminating the need for a surround and spider to center and suspend the panel and voice coil. The masses of the surround and spider add to the inertia on the axially-reciprocating diaphragm in conventional audio transducers. The surround and spider further limit the range of motion of the axially-reciprocating cone and add mechanical resistance to that motion. In the electromagnetic lever diaphragm audio transducer, the robust suspension system at the fulcrum suspends and centers the panel and voice coil and allows the panel a greater range of movement while limiting inertial effects and thus increasing the efficiency of the electromagnetic lever diaphragm audio transducer.

Furthermore, the diaphragm design of the electromagnetic lever diaphragm audio transducer improves on conventional audio transducers by its ability to be easily adapted into a multiple-transducer horn-speaker system. The ability to shape the diaphragm or panel in accordance with the geometrical needs of the specific horn design allows the panel to be used as an integral active waveguide wall of the horn. The panel of one electromagnetic lever diaphragm audio transducer emits a range of sound frequencies into the horn while at the same time guiding the sound waves of the other transducers within the horn system with a minimal disruption in the continuity of the horn geometry. Similarly, the active wall panels that are disposed in horn walls and shown in FIGS. 29-42 provide a great advantage over conventional conical speakers placed in horn walls because the active wall panels emit a range of sound frequencies into the horn while guiding the sound waves of other drivers and/or transducers within the horn system without disrupting the paths of the sound waves traveling along the horn walls.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An electromagnetic transducer, comprising:
a frame;
a diaphragm disposed within said frame and coupled to said frame such that said diaphragm may rotate relative to said frame;
a panel-shaped former connected to said diaphragm;
a conductive coil connected to said former;
a magnetic assembly including a gap in which a magnetic field is provided, said gap being positioned to receive said conductive coil; and
said conductive coil being electrically charged within said gap to move such that said diaphragm rotates to generate sound waves.

2. The electromagnetic transducer of claim 1, wherein said former is a flat panel.

3. The electromagnetic transducer of claim 1, wherein said former is a curved panel and said conductive coil is curved to follow the contour of said former.

4. The electromagnetic transducer of claim 1, wherein said former is a curved panel and said conductive coil is curved to follow the contour of said former and said gap is curved to receive said panel and coil, such that as said diaphragm rotates, said panel and coil move in a radial path within said curved gap relative to said magnetic assembly.

5. The electromagnetic transducer of claim 1, wherein said former has two sides and said conductive coil is connected to said former between said sides.

6. The electromagnetic transducer of claim 1, wherein said former is in a generally rectangular pattern having generally parallel upper and lower sections and generally parallel side sections.

7. The electromagnetic transducer of claim 1, wherein said former includes a base that is connected to said diaphragm and said former includes a panel that is connected to said base and is curved with respect to said base.

8. The electromagnetic transducer of claim 1, wherein said former includes at least one gap therealong and said conductive coil extends across said gap between sections of said former on either side of said gap.

9. The electromagnetic transducer of claim 1, wherein said magnetic assembly includes opposite walls that define said gap and each of said walls includes a magnet exposed to said gap and oriented at least partially across from said other magnet, said conductive coil having an upper portion and a lower portion that are not positioned in said gap between said magnets when said diaphragm is in the rest position.

10. The electromagnetic transducer of claim 1, wherein said magnetic assembly includes opposite walls that define said gap and one of said walls includes a magnet exposed to said gap, said conductive coil having an upper portion and a lower portion that are not positioned across from said magnet when in said gap when said diaphragm is in the rest position.

11. The electromagnetic transducer of claim 1, wherein said diaphragm has top and bottom sides and includes a convex curved surface on at least one of said top and bottom sides and said diaphragm includes at least one groove along the surface of at least one of said top and bottom sides.

12. The electromagnetic transducer of claim 1, wherein a portion of said conductive coil extends out of said gap and said magnetic assembly when said diaphragm is at rest.

13. An electromagnetic transducer for use in a speaker, comprising:
a frame;
a diaphragm disposed within said frame and coupled to said frame such that said diaphragm may rotate relative to said frame;
a former connected to said diaphragm, wherein said former is a curved panel;
a conductive coil connected to said former and configured to curve along said former;
a magnetic assembly including a gap in which a magnetic field is provided, said gap being positioned to receive said conductive coil; and
said conductive coil being electrically charged within said gap to move such that said diaphragm rotates relative to said frame to generate sound waves.

14. The electromagnetic transducer of claim 13, wherein said gap is curved to receive said former and coil, such that as said diaphragm rotates, said former and coil move in a radial path within said curved gap relative to said magnetic assembly.

15. The electromagnetic transducer of claim 13, wherein said former has two sides and said conductive coil is connected to said former between said sides.

16. The electromagnetic transducer of claim 13, wherein said former is in a generally rectangular pattern having generally parallel upper and lower sections and generally parallel side sections.

17. The electromagnetic transducer of claim 13, wherein said former includes at least one gap therealong and said conductive coil extends across said gap between sections of said former on either side of said gap.

18. The electromagnetic transducer of claim 13, wherein said magnetic assembly includes opposite walls that define said gap and each of said walls includes a magnet exposed to said gap and at least partially oriented across from said other magnet, said conductive coil having an upper portion and a lower portion that are not positioned between said magnets when in said gap when said diaphragm is in the rest position.

19. The electromagnetic transducer of claim 13, wherein said magnetic assembly includes opposite walls that define said gap and one of said walls includes a magnet exposed to said gap, said conductive coil having an upper portion and a lower portion that are not positioned across from said magnet when in said gap when said diaphragm is in the rest position.

20. The electromagnetic transducer of claim 13, wherein said magnetic assembly has at least one outer wall extending at an angle with respect to said conductive coil such that said magnetic field in said gap flows generally perpendicularly to said conductive coil as said coil moves within said gap.

21. The electromagnetic transducer of claim 13, wherein said diaphragm has top and bottom sides and includes a convex curved surface on at least one of said top and bottom sides and said diaphragm includes at least one groove along the surface of at least one of said top and bottom sides.

22. The electromagnetic transducer of claim 13, wherein a portion of said conductive coil extends out of said gap and said magnetic assembly when said diaphragm is at rest.

23. An electromagnetic transducer for use in a speaker, comprising:
a frame;
a diaphragm disposed within said frame and coupled to said frame such that said diaphragm may rotate relative to said frame, said diaphragm having top and bottom sides and including at least one groove along the surface of at least one of said top and bottom sides;
a conductive coil connected to said diaphragm;
a magnetic structure connected to said frame, said magnetic structure including a gap in which a magnetic field is provided, said gap being positioned to receive said conductive coil; and
said conductive coil being electrically charged within said gap to move such that said diaphragm rotates about said rotational axis to displace air and generate sound waves.

24. The electromagnetic transducer of claim 23, wherein said diaphragm includes a series of grooves extending longitudinally along at least one of said top and bottom sides of said diaphragm.

25. The electromagnetic transducer of claim 23, wherein said diaphragm includes a curved surface on at least one of said top and bottom sides.

26. The electromagnetic transducer of claim 23, wherein said diaphragm includes a first series of grooves and a second series of grooves extending along at least one of said top and bottom sides of said diaphragm, said grooves of said first series having a different size than said grooves of said second series.

27. The electromagnetic transducer of claim 23, wherein said diaphragm includes convex curved surfaces on each of said top and bottom sides.

28. The electromagnetic transducer of claim 23, wherein said conductive coil is connected to a curved former and said curved former is connected to said diaphragm, said gap being curved to receive said former and coil, such that as said diaphragm rotates, said former and coil move in a radial path within said curved gap relative to said magnetic structure.

29. The electromagnetic transducer of claim 28, wherein said former includes at least one gap therealong and said conductive coil extends across said gap between sections of said former on either side of said gap.

30. The electromagnetic transducer of claim 23, wherein said diaphragm is made of rigid foam.

31. The electromagnetic transducer of claim 23, wherein said diaphragm is made at least partially of fiber.
